(19) United States
(12) Patent Application Publication
(10) Pub. No.: US 2010/0266222 A1
(43) Pub. Date: Oct. 21, 2010

(54) BAG

(75) Inventors: John E. Rusnak, Aurora, IL (US); Nancy M. Mack-Robles, Bolingbrook, IL (US); Jeffrey S. Stiglic, New Lenox, IL (US); Theodore J. Fish, Downers Grove, IL (US); John A. MacPherson, Aurora, IL (US)

Correspondence Address: THE CLOROX COMPANY, P.O. BOX 24305, OAKLAND, CA, 94623-1305, US

(73) Assignee: The Glad Products Company, Oakland, CA (US)

(21) Appl. No.: 12/759,310

(22) Filed: Apr. 13, 2010

Related U.S. Application Data
(60) Provisional application No. 61/169,574, filed on Apr. 15, 2009.

(51) Int. Cl. B65D 33/16; B65D 30/20; B65D 30/08; B31B 1/90; B31B 19/26

(52) U.S. Cl. 383/63; 383/120; 383/109; 493/214; 493/243

(57) ABSTRACT

A thermoplastic bag for storing food items may include a first sidewall and an opposing second sidewall joined to the first sidewall to define an interior volume. The first and second sidewalls may be made from pliable, sheet-like thermoplastic web material. The sidewalls may be formed with a pattern of ribs. When a tensioning force is applied to the sidewall, the ribs may open so that the sidewall may become generally more planar. Opening the ribs may cause the sidewalls to stretch or expand thereby adding to the overall area of the bag. The thermoplastic material may have a shape memory characteristic that may cause the ribs to reform after the tensioning force is alleviated.

### CROSS REFERENCE TO RELATED APPLICATIONS

This application claims the benefit of U.S. Provisional Application No. 61/169,574, filed on Apr. 15, 2009, which is hereby incorporated by reference in its entirety.

### BACKGROUND

Among their many applications, thermoplastic bags may be used to receive and store food items. Such bags are typically made from pliable thermoplastic sidewalls that are overlaid and joined together along their edges to provide an interior volume that may receive the food items to be stored. The interior volume is accessible via an opening. To seal closed the opening, the bag may include interlocking closure strips attached proximate the opening. To prevent the stored food items from going stale or spoiling, it is desirable to reduce the amount of air in the interior volume of the bag prior to engaging the closure strips. This may be accomplished by pressing the sidewalls together to displace the air through the opening. However, some air may remain in the interior volume and may adversely affect the stored food items. Another issue that may arise is that the items inserted may be of such size or bulk that, even though they may fit through the opening, their size and bulk prevents or obstructs the interlocking closure strips from re-engaging to close the bag. Accordingly, there is a need for an improved manner of reducing air that may otherwise become trapped in the interior volume. There is also a need for a bag which may accommodate large or bulky items.

### BRIEF SUMMARY

The bag may be made from pliable thermoplastic web material that may be in the form of a planar sheet and that may include a first sidewall and an opposing second sidewall overlaid and joined to the first sidewall to provide an interior volume. The interior volume is accessible via an opening. To seal closed the opening after inserting food items into the interior volume, the bag may include first and second interlocking closure strips. At least a portion of one of the otherwise planar sidewalls may be formed with a pattern such that at least some of sidewall material bunches or gathers together. The pattern may be a plurality of protruding ridges or ribs or the pattern may be in the form of a plurality of elongated, linear ribs formed into the sidewall material. The ribs may be collected together in discrete regions across the sidewall or the ribs may extend across the entire or substantial portion of the sidewalls. The ribs may cause the sidewall material to bunch or collect together in a manner that may shrink or decrease the overall planar area or dimensions of the sidewall. However, when a force is applied to the sidewall, the material bunched together within the area of patterning may unfold and stretch apart thereby increasing the overall planar area of the sidewall. In various embodiments, the plastic sidewall material may have a shape memory characteristic that may cause the pattern to reform and thereby re-shrink the sidewall. Hence, the sidewall may tend to have an elastic or yieldable characteristic that may allow the bag to expand in order to accommodate larger or bulkier items.

Another possible result of forming the sidewalls with a pattern is that the opposing sidewalls forming the finished bag may tend to adhere or stick to each other. When the opposing sidewalls of the bag are placed adjacent to each other with their inner surfaces facing each other and thereby collapsing the interior volume, the pattern may tend to pinch or grasp the material of the opposing sidewall. Hence, the opposing sidewalls may tend to tack or adhere to each other in a manner that maintains the interior volume in a collapsed state and the bag in a flattened state. However, the degree of adherence or tack between the sidewalls may be sufficiently small so that the sidewalls may be readily separated when the bag is opened and objects are inserted, or when air is billowed or forced into the interior volume to open the bag.

To produce a bag with the pattern, a high speed manufacturing process may be employed that processes planar, continuous webs of thermoplastic material into the finished bags. The process may utilize two opposing cylindrical rollers that have a pattern formed on their cylindrical surface. The web may be directed by the processing equipment between the rollers thereby impressing the pattern into the web material. Additional processing equipment may be included that processes the web into a finished bag.

A possible advantage of forming the sidewalls with a pattern so that they may stretch, may be that engaging the interlocking closure strips may be simplified even when the bag contains large or bulky items. Another possible advantage of the forming the sidewalls with a pattern may be that the bag may have a more desirable appearance and feel. These and other advantages and features of the bag with patterning will become apparent from the description and the accompanying drawings.

### BRIEF DESCRIPTION OF THE DRAWINGS

FIG. 1 is a perspective view of a thermoplastic bag, the sidewalls of the bag being formed with a pattern such that the sidewall material exhibits an elastic or yieldable characteristic, the pattern being arranged in a plurality of discrete regions.

FIG. 2 is a perspective view of the area indicated in FIG. 1 by circle 2-2 illustrating a pattern formed into the sidewall of the bag.

FIG. 3 is a perspective view similar to that of FIG. 2, illustrating the sidewall placed under a tensioning force such that the thermoplastic material stretches out.

FIG. 4 is a perspective view of another embodiment of a thermoplastic bag for storing food items, the sidewall of the bag being formed with another embodiment of a pattern such that the sidewall material has an elastic or yieldable characteristic, the pattern including a plurality of parallel ribs extending across the sidewall.

FIG. 5 is a cross-sectional view taken along line 5-5 of the bag shown in FIG. 4

FIG. 6 is a cross-sectional view taken of the area indicated by line 6-6 of the bag shown in FIG. 4 illustrating the parallel, adjacent ribs.

FIG. 7 is a cross-sectional view similar to that of FIG. 6 illustrating the ribs being opened by an applied tensioning force.

FIG. 8 is front perspective view of a bag with a pattern, the bag accommodating an object and having interlocking fastening strips sealing closed the opening.

FIG. 9 is a top perspective view of a bag with a pattern, the bag being in a partially flattened condition and with the sidewalls being partly separated to accommodate an object.

FIG. 10 is a cross-sectional view of the area taken along line 10-10 of FIG. 9 showing the sidewalls of the bag adhering or sticking adjacently together.

FIG. 11 is an elevational view of another embodiment of a thermoplastic bag including a pattern on only a portion of the sidewall.

FIG. 12 is an elevational view of another embodiment of a thermoplastic bag including a pattern on only a portion of the sidewall.

FIG. 13 is an elevational view of another embodiment of a thermoplastic bag including a pattern on only a portion of the sidewall.

FIG. 14 is an elevational view of another embodiment of a thermoplastic bag including a pattern on only a portion of the sidewall.

FIG. 15 is a schematic representation of a high speed manufacturing process for producing the food storage bags which may process a single web of thermoplastic material.

FIG. 16 is a perspective view of the cylindrical rollers used in the manufacturing process of FIG. 15.

FIG. 17 is a schematic representation of another embodiment of a high speed manufacturing process for producing the food storage bags which may process multiple webs of thermoplastic material.

FIG. 18 is a perspective view of the cylindrical rollers which may be used in the manufacturing process of FIG. 17.

FIG. 19 is a view of the cylindrical rollers taken along circle 19-19 of FIG. 18 depicting a web being directed between the rollers.

FIG. 20 is an elevational view of another embodiment of a thermoplastic bag including a pattern on only a portion of the sidewall.

FIG. 21 is an elevational view of another embodiment of a thermoplastic bag including a pattern on only a portion of the sidewall.

FIG. 22 is an elevational view of another embodiment of a thermoplastic bag including a pattern on only a portion of the sidewall.

FIG. 23 is an elevational view of another embodiment of a thermoplastic bag including a pattern on only a portion of the sidewall.

FIG. 24 is a perspective view of another embodiment of a bag.

FIG. 25 is an elevational view of another embodiment of a bag including a pattern on only a portion of the sidewall.

FIG. 26 is an elevational view of another embodiment of a bag including a pattern on only a portion of the sidewall.

FIG. 27 is an elevational view of another embodiment of a bag including a pattern on only a portion of the sidewall.

FIG. 28 is an elevational view of another embodiment of a bag including a pattern on only a portion of the sidewall.

FIG. 29 is a perspective view of another embodiment of rollers which may be used for the manufacturing process.

FIG. 30 is a perspective view of another embodiment of a bag.

FIG. 31 is a cross-sectional view of another embodiment of the fastening strips.

FIG. 32 is a cross-sectional view of another embodiment of the fastening strips.

FIG. 33 is a cross-sectional view of another embodiment of the fastening strips.

FIG. 34 is a cross-sectional view of another embodiment of the fastening strips.

FIG. 35 is a perspective view of another embodiment of a bag.

FIG. 36 is a cross-sectional view taken along line 36-36 of FIG. 35.

FIG. 37 is a perspective view of another embodiment of a bag.

FIG. 38 is a perspective view of another embodiment of a bag.

FIG. 39 is a cross-sectional view taken along line 39-39 of FIG. 38.

FIG. 40 is a perspective view of another embodiment of a bag.

FIG. 41 is a perspective view of another embodiment of a bag.

FIG. 42 is a perspective view of another embodiment of a bag.

FIG. 43 is a perspective view of another embodiment of a bag.

FIG. 44 is a perspective view of another embodiment of a bag.

FIG. 45 is a perspective view of another embodiment of a bag.

FIG. 46 is a perspective view of another embodiment of a bag.

FIG. 47 is a perspective view of another embodiment of a bag.

### DESCRIPTION

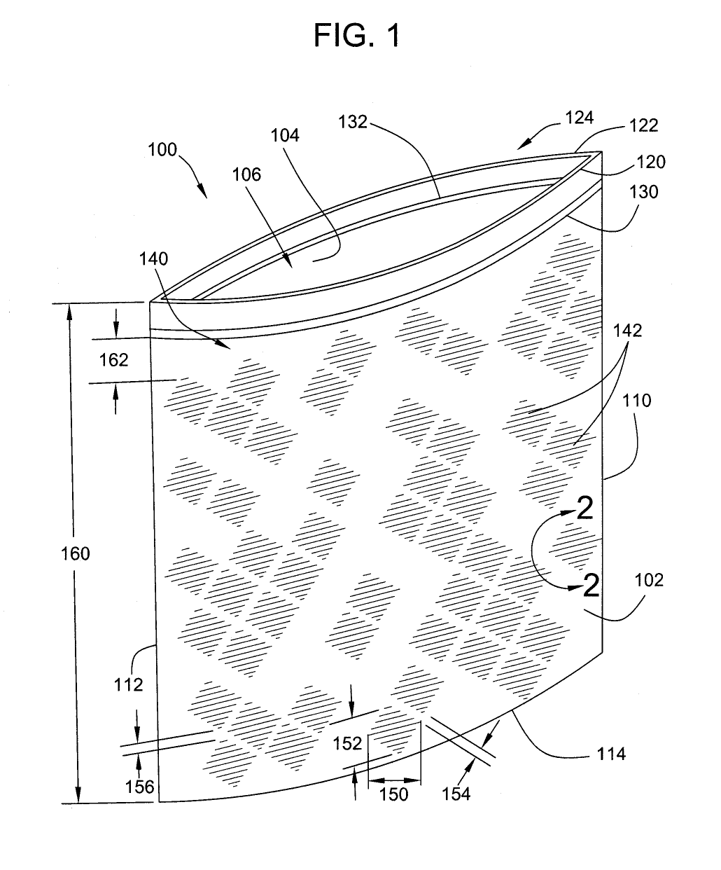

Referring to FIG. 1, an embodiment of a thermoplastic bag 100 is illustrated. The bag 100 may include a first sidewall 102 of pliable thermoplastic material and an opposing second sidewall 104 overlaying and joined to the first sidewall to delineate an interior volume 106. The sidewalls 102, 104 may be rectangular in shape and may be joined along a first side edge 110, a second side edge 112, and a closed bottom edge 114 extending between the first and second side edges 110, 112. However, in other embodiments, the sidewalls may have other shapes, and the bag may have different numbers of edges and sidewalls. The side edges may be formed by any suitable method including, for example, heat sealing the thermoplastic material together.

To access the interior volume 106, the first and second top edges 120, 122 of the respective first and second sidewalls remain un-joined to provide an opening 124. To releasably close the opening 124 to, for example, better preserve food items, the first and second sidewalls 102, 104 may include first and second fastening strips 130, 132. The first and second fastening strips 130, 132 may be formed from extruded, flexible thermoplastic and may extend between the first and second side edges 110, 112. The first and second fastening strips 130, 132 may releasably engage to form a seal which closes the opening 124. Of course, in other embodiments or in combination with the interlocking strips, other methods such as the use of pressure sensitive or cold seal adhesives such as those disclosed in U.S. Pat. No. 6,149,304, herein incorporated by reference in its entirety, heat-sealing, or cling may be employed to seal the open top edge.

The first and second sidewalls 102, 104 may be formed from any suitable thermoplastic material formed or drawn into a flexible, pliable thin walled sheet or web. The thickness of the thermoplastic web may have a first range of about 0.0005 inches (0.0013 cm) to about 0.005 inches (0.0127 cm), and a second range of about 0.0018 inches (0.0046 cm) to about 0.0026 inches (0.0066 cm). In one embodiment, the thickness may be about 0.0026 inches (0.0066 cm). Examples of suitable thermoplastic materials may include polyethylenes, such as, high density polyethylene (HDPE), low density polyethylene (LDPE), linear low density polyethylene (LLDPE), polypropylene (PP), ethylene vinyl acetate (EVA), nylon, polyester, polyamide, ethylene vinyl alcohol, or other materials or combinations thereof, and may be formed in single or multiple layers. When intended for storing food items, the thermoplastic material of the bag typically may be transparent, though in other embodiments the thermoplastic material may be translucent, opaque, or tinted. Furthermore, the material used for the sidewalls may be a gas impermeable material.

The first and second sidewalls 102, 104 may include a pattern or patterning 140 that may be formed into the thermoplastic material. In the illustrated embodiment, the pattern 140 may be provided as a plurality of discrete regions or networks 142 that may be formed apart from each other and across the otherwise smooth and planar sidewalls 102, 104. The plurality of regions 142 may extend between the first and second side edges 110, 112 and from just below the interlocking fastening strips 130, 132 to the closed bottom edge 114. The patterning 140 within the regions 142 may provide the sidewalls with an elastic or yieldable characteristic that enables the sidewalls to stretch or expand, and thereby accommodate larger objects. Examples of such patterns and similar features are disclosed in U.S. Pat. No. 6,139,185; U.S. Publication No. 2004/0134923; U.S. Pat. No. 6,394,651; U.S. Pat. No. 6,394,652; U.S. Pat. No. 6,150,647; U.S. Pat. No. 6,513,975; and U.S. Pat. No. 6,695,476, each of which is herein incorporated by reference in their entirety.

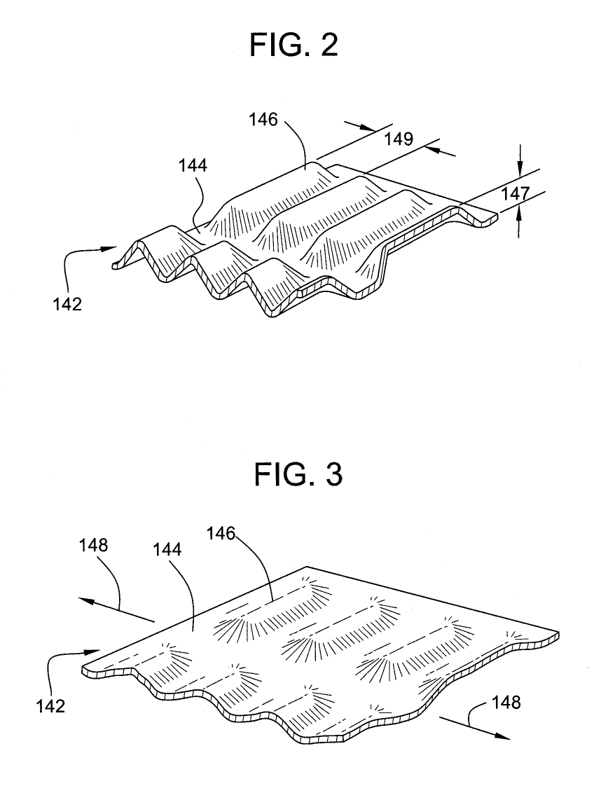

Referring to FIGS. 2 and 3, the normally planar, sheet-like thermoplastic material of the sidewalls within each patterned region 142 may be formed into a series of parallel ribs. Hence, the sidewall material may be contracted or pulled together by the parallel ribs. The regions 142 may include smooth, planar areas 144 corresponding to the sidewalls and a plurality of first linear, ridge-like ribs or protuberances 146 that may be formed into the smooth planar areas in a parallel, adjacent relation to provide the ribs. Each raised rib 146 may have a height 147 measured with respect to the planar areas 144. The height 147 of each rib may have a first range of about 0.002 inches (0.0051 cm) to about 0.1 inches (0.254 cm), and a second range of about 0.02 inches (0.0508 cm) to about 0.04 inches (0.1016 cm). In one embodiment, the height 147 may be about 0.03 inches (0.076 cm). The ribs 146 may be separated by a distance 149. The distance 149 may have a first range of about 0.03 inches (0.0762 cm) to about 0.2 inches (0.508 cm), and a second range of about 0.04 inches (0.762 cm) to about 0.08 inches (0.2032 cm). In one embodiment, the distance 149 may be about 0.06 inches (0.1524 cm).

When in an un-tensioned state illustrated in FIG. 2, the ribs 146 may appear bunched or contracted together and constrict the sidewall. However, when an appropriate tensioning force 148 is applied, as indicated in FIG. 3, the ribs 146 may be able to unbend or geometrically deform so that the ribs may become substantially co-planar with each other and with the planar areas 144. As will be appreciated, this action may stretch or expand the pattern thereby adding to the overall area of the sidewalls. Moreover, the thermoplastic material into which the pattern 140 is formed may demonstrate shape memory causing the raised ribs 146 to close when any applied forces are removed. Thus, the sidewalls of the bag may demonstrate a degree of resiliency or elasticity allowing the bag to stretch and/or contract.

Referring to FIG. 1, each discrete region 142 may have a length 150. The length 150 may have a first range of about 0.1 inches (0.254 cm) to about 5 inches (12.7 cm), and a second range of about 0.3 inches (0.762 cm) to about 0.85 inches (2.154 cm). In one embodiment, the length 150 may be about 0.35 inches (0.889 cm). Each discrete region 142 may have a height 152. The height 152 may have a first range of about 0.9 inches (0.2286 cm) to about 4.95 inches (12.573 cm), and a second range of about 0.28 inches (0.711 cm) to about 0.78 inches (1.981 cm). In one embodiment, the height 152 may be about 0.3 inches (0.762 cm). Each discrete region 142 may be spaced apart and separated from each adjacent discrete region by a distance 154. The distance 154 may have a first range of about 0.02 inches (0.0508 cm) to about 1 inch (2.54 cm), and a second range of about 0.05 inches (0.127 cm) to about 0.15 inches (0.381 cm). In one embodiment, the distance 154 may be about 0.1 inches (0.254 cm). Each discrete region 142 may be spaced apart and separated from each adjacent discrete region by a distance 156. The distance 156 may have a first range of about 0.12 inches (0.3048 cm) to about 1.5 inches (3.8 cm), and a second range of about 0.16 inches (0.41 cm) to about 0.36 inches (0.91 cm). In one embodiment, the distance 156 may be about 0.24 inches (0.6096 cm).

To avoid interfering with the operation of the first and second fastening strips, referring to FIG. 1, the patterning 140 may terminate below the fastening strip 130. The bag 100 may have a height 160 measured between the closed bottom edge 114 and the opening 124. The height 160 may have a first range of about 4 inches (10.16 cm) to about 33 inches (83.82 cm), and a second range of about 8.75 inches (22.225 cm) to about 11.75 inches (29.845 cm). In one embodiment, the height 160 may be about 11.75 inches (29.845 cm). The pattern 150 may terminate a distance 162 below the fastening strip. The distance 162 may have a first range of about 0 inches (0 cm) to about 23 inches (58.42 cm), and a second range of about 0.25 inches (0.635 cm) to about 2.25 inches (5.715 cm). In one embodiment, the distance 162 may be about 0.5 inches (1.27 cm).

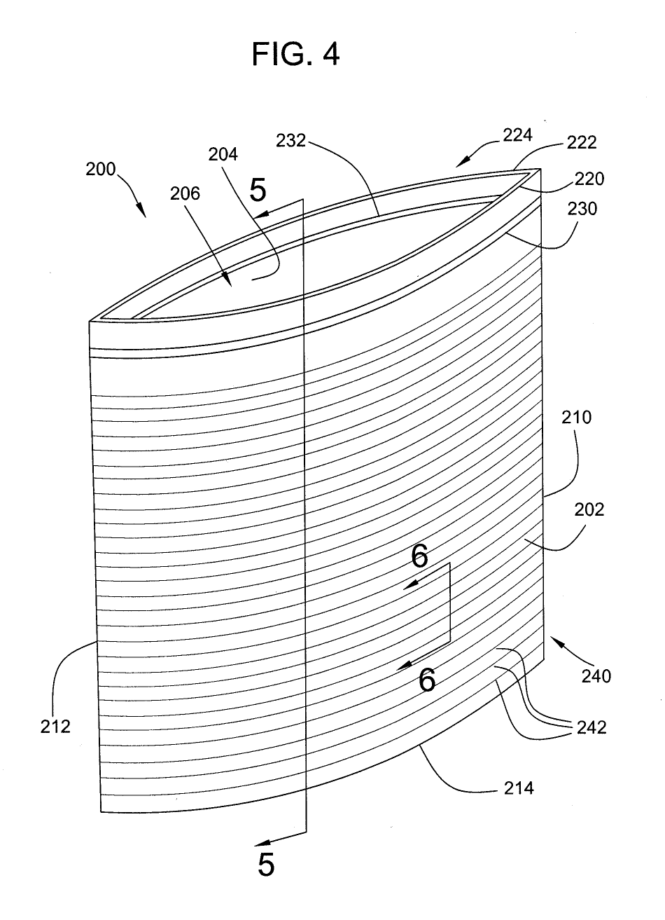

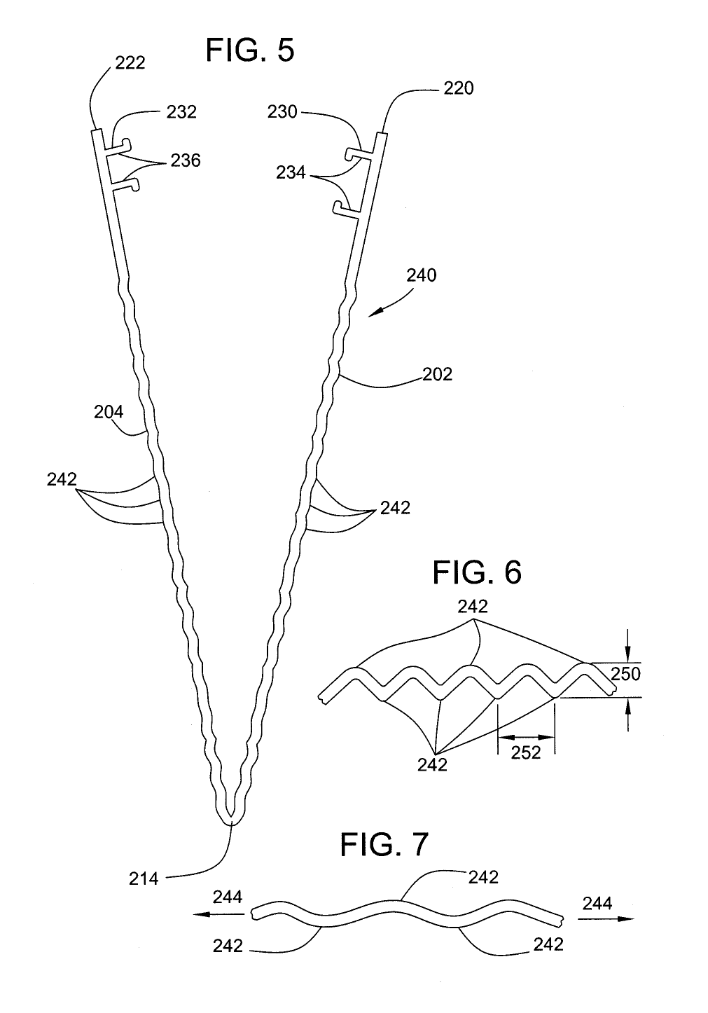

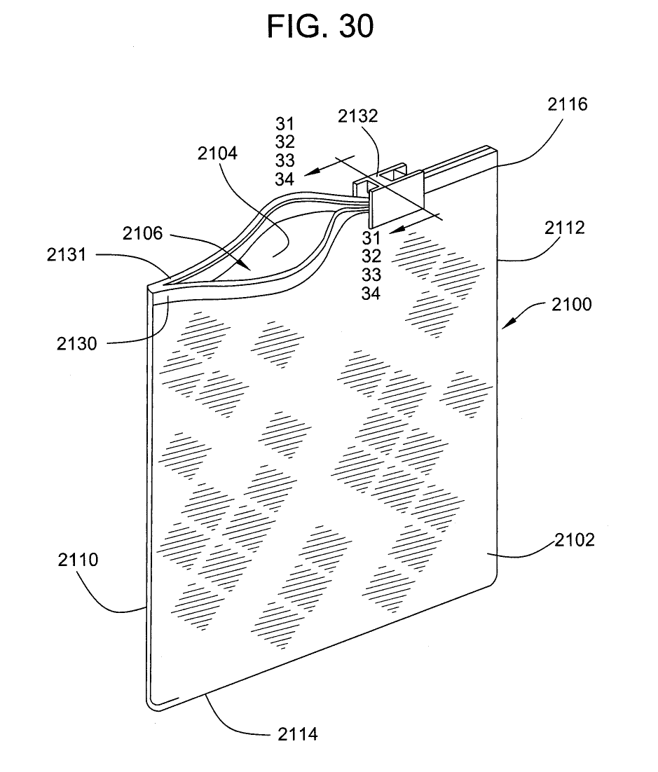

The patterning formed into the sidewalls of the bag may have various other forms. For example, referring to FIGS. 4 and 5, there is illustrated another embodiment of a thermoplastic bag 200 that may be intended for accommodating food items and the like. The bag 200 may include a first sidewall 202 and an opposing second sidewall 204 overlaid and joined to the first sidewall along first and second side edges 210, 212 and a closed bottom edge 214 to define an interior volume 206. The interior volume 206 may be accessed via an opening 224 provided by the first and second un-joined top edges 220, 222 of the respective first and second sidewalls 202, 204. To seal closed the opening 224, first and second interlocking fastening strips 230, 232 may be attached to the first and second sidewalls proximate the un-joined top edges 220, 222. In the illustrated embodiment, the first fastening strip 230 may include a pair of spaced-apart, inwardly facing hooks or barbs 234 which may mate with a corresponding pair of space-apart, oppositely directed hooks or barbs 236. Other embodiments of fastening strips are described herein, such as, with respect to FIGS. 30-34.

Referring to FIG. 4, to provide elasticity to the bag 200, the thermoplastic sidewalls 202, 204 may be formed with a pattern 240 of linear elongated ribs 242 arranged adjacent and parallel and that may extend from the first side edge 210 to the second side edge 212 and from proximate the fastening strips 230, 232 toward the closed bottom edge 214. As shown in FIG. 6, the ribs 242 may form the sidewall material so that it is bunched or constricted together into a corrugated-like pattern. Each rib 242 may have a height 250 that falls within a first range of about 0.002 inches (0.0051 cm) to about 0.1 inches (0.254 cm), and a second range of about 0.02 inches (0.0508 cm) to about 0.04 inches (0.1016 cm). In one embodiment, the height 250 may be about 0.03 inches (0.076 cm). The ribs 242 may be separated by a distance 252. The distance 252 may have a first range of about 0.03 inches (0.0762 cm) to about 0.2 inches (0.508 cm), and a second range of about 0.04 inches (0.1016 cm) to about 0.08 inches (0.2032 cm). In one embodiment, the distance 252 may be about 0.06 inches (0.1524 cm).

However, when an appropriate tensioning force 244 is applied, as illustrated in FIG. 7, the ribs 242 may open so that the height 247 may be reduced and the sidewall may stretch and/or expand. Additionally, as mentioned above, the thermoplastic material may demonstrate shape memory so that, after the tensioning forces are removed, the pattern may reform. Hence, the sidewalls may have an elastic or yieldable characteristic as discussed above.

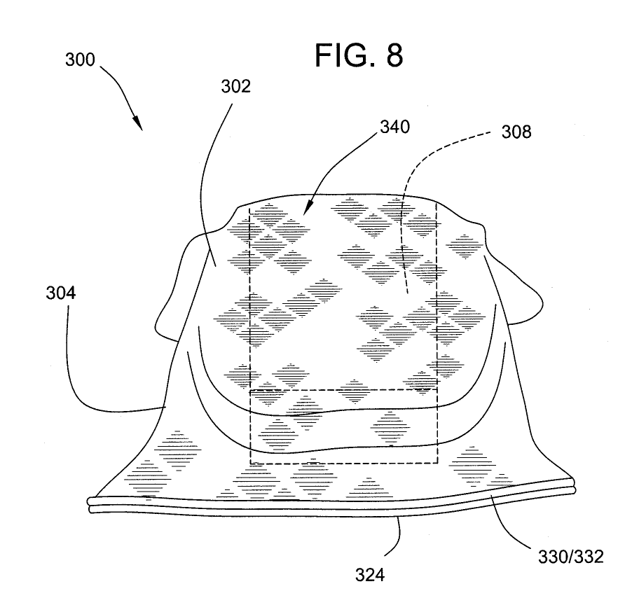

A bag with a pattern formed on the sidewalls may provide various benefits over conventional bags without such a patterning. For example, referring to FIG. 1, it may be appreciated that the interior volume 106 has a given dimension that is at least in part determined by the width of the bag 100. In a bag without patterning, the volume will be substantially fixed. However, referring to FIG. 8, there is illustrated a bag 300 having a pattern 340 formed on the sidewalls 302, 304 accommodating a large or bulky object 308, such as, a cardboard box, piece of fruit, meat or other item to be stored in a bag. The opening 324, through which the item 308 may be inserted into the bag 300, may be closed by the first and second interlocking fastening strips 330, 332. Because of its size, the object 308 may cause the first and second sidewalls 302, 304 to stretch or expand around it in order for the bag to accommodate the object. As described above, the elasticity provided by the pattern 340 allows for the stretching of the sidewalls 302, 304.

Additionally, the elastic quality may allow for easier manipulation of the opening 324 after insertion of an object to facilitate aligning and engaging the fastening strips 330, 332. As may be appreciated, in a bag without such a quality, engaging the fastening strips to close the opening may be difficult when the bag is substantially filled or accommodating oversized items. Another possible advantage is that the elasticity provided by pattern 340 causes the sidewalls 302, 304 to constrict tightly about the inserted object 308 so as to reduce the interior volume space between the sidewalls otherwise available for accommodating air. This may facilitate minimizing the amount of air retained in the interior volume after engaging the fastening strips thereby helping to preserve food items and to reduce freezer burn.

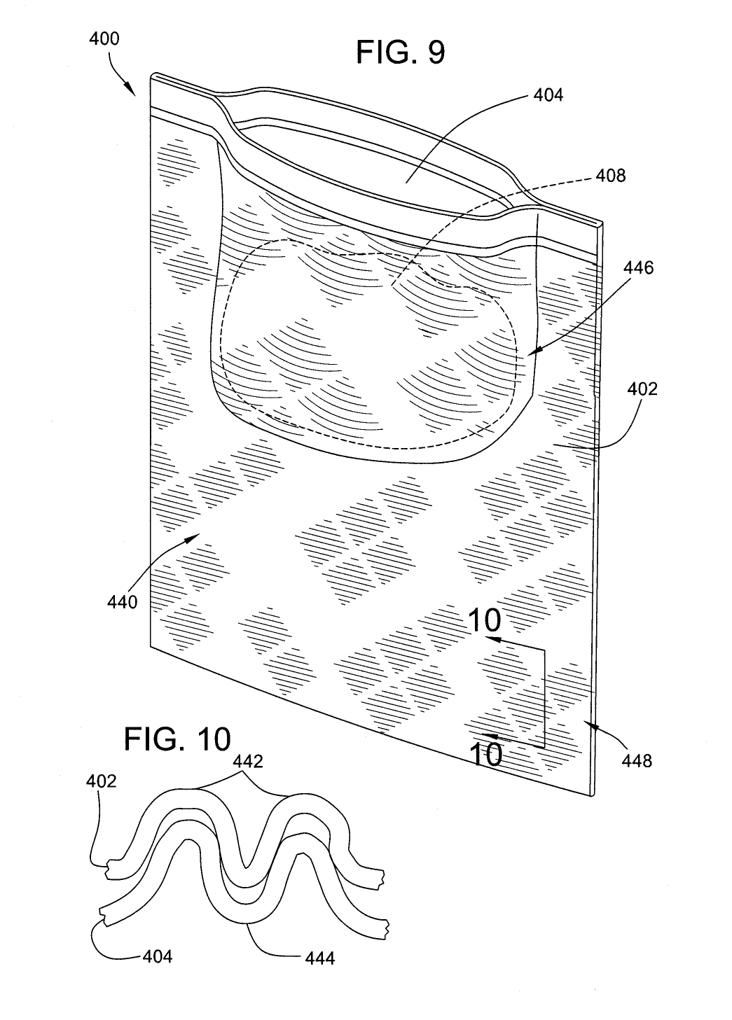

Referring to FIG. 9, there is illustrated another embodiment of a thermoplastic bag 400 having a pattern 440 formed on the sidewalls 402, 404 and an object 408, such as, a piece of meat, partially inserted into it. The patterns 440, which as described herein may be formed of ribs, may cause the sidewalls 402, 404 to stick or adhere together thereby collapsing the interior volume. For example, referring to FIG. 10, the ribs 442 formed on the first sidewall 402 may pinch or grasp to the ribs 444 formed on the second sidewall 404, thereby holding the interior surfaces of the two sidewalls adjacently together. However, when the object is inserted into the bag 400, the patterns 440 may open or stretch out within the area 446 of the bag accommodating the object thereby enabling the sidewalls to separate and stretch around the object. If the object is oddly shaped or smaller than the bag 400, the sidewalls 402, 404 in the area 448 not accommodating the object may remain adhered together. This may minimize the amount of air that may become trapped in the interior volume after engaging the fastening strips, also helping to preserve food items and prevent freezer burn.

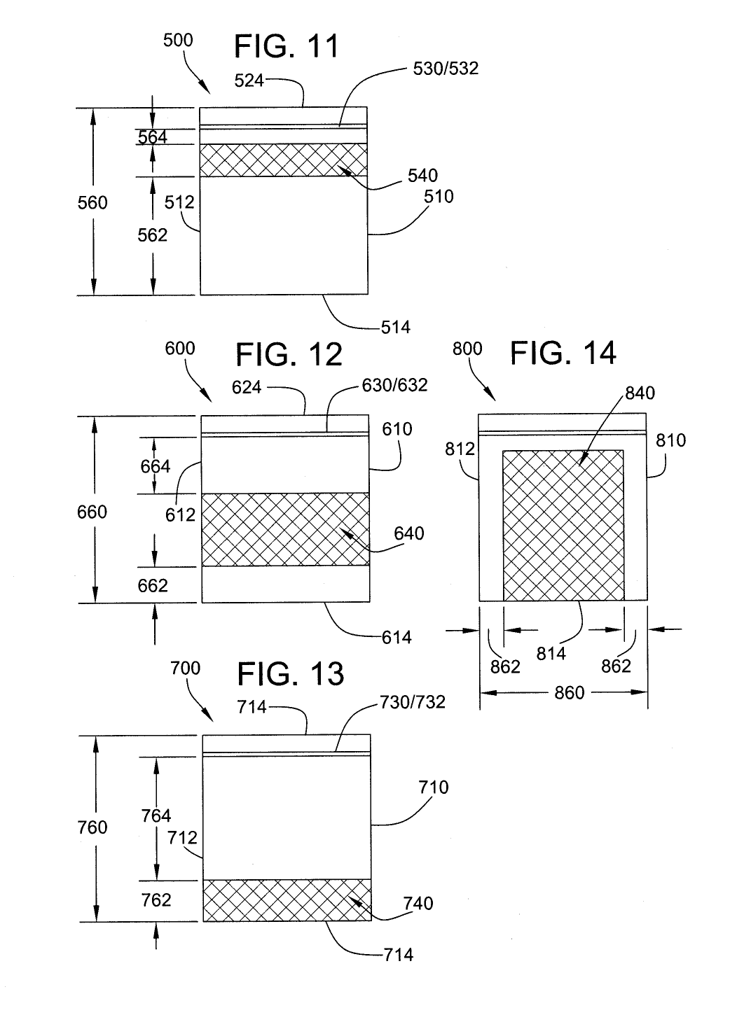

The pattern may be arranged on the first and/or second sidewalls in many different ways. For example, as described above, the pattern may be applied over substantially the entire sidewall area. However, referring to the embodiment of the bag 500 illustrated in FIG. 11, the pattern 540 may be applied only to the top half of the bag proximate the fastening strips 530, 532 and between the first and second side edges 510, 512. The area with the pattern 540 may cover a percentage of the bag sidewall. The percentage of area with the pattern may have a first range of 5% to 98% and a second range of 20% to 80%. In one embodiment, the percentage may be 60%. In a bag 500 having a height 560, the patterning 540 may be located a distance 562 above the bottom edge 514. The distance 562 may be a percentage of the height 560 and the percentage may have a first range of about 0% to about 70%, and a second range of about 35% to about 70%. In one embodiment, the percentage may be about 50%. The patterning 540 may be located a distance 564 below the fastening strips 530, 532. The distance 564 may be a percentage of the height 560 and the percentage may have a first range of about 0% to about 85%, and a second range of about 2% to about 26%. In one embodiment, the percentage may be about 5%. For example, in a bag 500 having a height 560 of about 11.75 inches (29.845 cm), the patterning 540 may be located a distance 562 above the bottom edge 514. The distance 562 may have a first range of about 0 inches (0 cm) to about 9.75 inches (24.765 cm), and a second range of about 4 inches (10.16 cm) to about 8 inches (20.32 cm). In one embodiment, the distance 562 may be about 6 inches (15.24 cm). The patterning 540 may be located a distance 564 below the fastening strips 530, 532. The distance 564 may have a first range of about 0 inches (0 cm) to about 10 inches (25.4 cm), and a second range of about 0.25 inches (0.635 cm) to about 2.25 inches (5.715 cm). In one embodiment, the distance 564 may be about 0.5 inches (1.27 cm). In another example, in a bag 500 having a height 560 of about 8.75 inches (22.225 cm), the patterning 540 may be located a distance 562 above the bottom edge 514. The distance 562 may have a first range of about 0 inches (0 cm) to about 6.75 inches (17.145 cm), and a second range of about 3 inches (7.62 cm) to about 5 inches (12.7 cm). In one embodiment, the distance 562 may be about 4 inches (10.16 cm). The patterning 540 may be located a distance 564 below the fastening strips 530, 532. The distance 564 may have a first range of about 0 inches (0 cm) to about 7 inches (17.78 cm), and a second range of about 0.25 inches (0.635 cm) to about 2.25 inches (5.715 cm). In one embodiment, the distance 564 may be about 0.5 inches (1.27 cm).

Referring to FIG. 12, in another embodiment of a bag 600, the pattern 640 may be applied across the middle portion of the bag between the first and second side edges 610, 612. The area with the pattern 540 may cover a percentage of the bag sidewall. The percentage of area with the pattern may have a first range of 5% to 98% and a second range of 20% to 80%. In one embodiment, the percentage may be 60%. In a bag 600 having a height 660, the patterning 640 may be located a distance 662 above the bottom edge 614. The distance 662 may be a percentage of the height 660 and the percentage may have a first range of about 0% to about 85%, and a second range of about 4% to about 50%. In one embodiment, the percentage may be about 30%. The patterning 640 may be located a distance 664 below the fastening strips 630, 632. The distance 664 may be a percentage of the height 660 and the percentage may have a first range of about 0% to about 75%, and a second range of about 8% to about 50%. In one embodiment, the percentage may be about 35%. For example, in a bag 600 having a height 660 of 11.75 inches (29.845 cm), the patterning 640 may be located a distance 662 above the bottom edge 614. The distance 662 may have a first range of about 0 inches (0 cm) to about 9.75 inches (24.765 cm), and a second range of about 0.5 inches (1.27 cm) to about 6 inches (15.24 cm). In one embodiment, the distance 662 may be about 4 inches (1.57 cm). The patterning 640 may be located a distance 664 below the fastening strips 630, 632. The distance 664 may have a first range of about 0 inches (0 cm) to about 8.75 inches (22.225 cm), and a second range of about 1 inch (2.54 cm) to about 6 inches (15.24 cm). In one embodiment, the distance 664 may be about 5 inches (12.7 cm). In another example, in a bag 600 having a height 660 of 8.75 inches (22.225 cm), the patterning 640 may be located a distance 662 above the bottom edge 614. The distance 662 may have a first range of about 0 inches (0 cm) to about 6.75 inches (17.14 cm), and a second range of about 0.5 inches (1.27 cm) to about 5 inches (12.70 cm). In one embodiment, the distance 662 may be about 3 inches (7.62 cm). The patterning 640 may be located a distance 664 below the fastening strips 630, 632. The distance 664 may have a first range of about 0 inches (0 cm) to about 5.75 inches (14.60 cm), and a second range of about 1 inch (2.54 cm) to about 4 inches (10.16 cm). In one embodiment, the distance 664 may be about 3 inches (7.62 cm).

Referring to FIG. 13, in another embodiment of a bag 700, the pattern 740 may be applied along the bottom edge 714 of the bag between the first and second side edges 710, 712. The area with the pattern 740 may cover a percentage of the bag sidewall. The percentage of area with the pattern may have a first range of 5% to 98% and a second range of 20% to 80%. In one embodiment, the percentage may be 60%. In a bag 700 having a height 760, the patterning 740 may extend a distance 762 above the bottom edge 714. The distance 762 may be a percentage of the height 760 and the percentage may have a first range of about 8% to about 95%, and a second range of about 40% to about 70%. In one embodiment, the percentage may be about 50%. The patterning 740 may be located a distance 764 below the fastening strips 730, 732. The distance 764 may be a percentage of the height 760 and the percentage may have a first range of about 0% to about 85%, and a second range of about 30% to about 70%. In one embodiment, the percentage may be about 50%. For example, in a bag 700 having a height 760 of 11.75 inches (29.845 cm), the patterning 740 may extend a distance 762 above the bottom edge 714. The distance 762 may have a first range of about 0.5 inches (1.27 cm) to about 9 inches (22.86 cm), and a second range of about 2 inches (5.08 cm) to about 8 inches (20.32 cm). In one embodiment, the distance 762 may be about 6 inches (15.24 cm). The patterning 740 may be located a distance 764 below the fastening strips 730, 732. The distance 764 may have a first range of about 0 inches (0 cm) to about 9.75 inches (24.765 cm), and a second range of about 3 inches (7.62 cm) to about 9 inches (22.86 cm). In one embodiment, the distance 764 may be about 6 inches (15.24 cm). In another example, in a bag 700 having a height 760 of 8.75 inches (22.225 cm), the patterning 740 may extend a distance 762 above the bottom edge 714. The distance 762 may have a first range of about 0.5 inches (1.27 cm) to about 7.75 inches (19.68 cm), and a second range of about 2 inches (5.08 cm) to about 5 inches (12.7 cm). In one embodiment, the distance 762 may be about 4 inches (10.16 cm). The patterning 740 may be located a distance 764 below the fastening strips 730, 732. The distance 764 may have a first range of about 0 inches (0 cm) to about 6.75 inches (17.14 cm), and a second range of about 2 inches (5.08 cm) to about 6 inches (15.24 cm). In one embodiment, the distance 764 may be about 4 inches (10.16 cm).

Referring to FIG. 14, there is illustrated another embodiment of a bag 800 wherein the patterning 840 may be offset from the side edges 810, 812 of the bag. The area with the pattern 840 may cover a percentage of the bag sidewall. The percentage of area with the pattern may have a first range of 5% to 98% and a second range of 20% to 80%. In one embodiment, the percentage may be 60%. The bag 800 may have a width 860 between the first and second side edges 810, 812. The patterning may be offset a distance 862 from the side edges and may be a percentage of the width 860. The percentage may have a first range of about 2.5% to about 50%, and a second range of about 5% to about 15%. In one embodiment, the percentage may be about 10%. For example, the bag 800 may have a width 860 between the first and second side edges 810, 812. The width 860 may have a first range of about 6 inches (15.24 cm) to about 24 inches (60.96 cm), and a second range of about 7 inches (17.78 cm) to about 10.6 inches (26.924 cm). In one embodiment, the width 860 may be about 10.562 inches (26.8 cm). The patterning may be offset a distance 862 from the side edges. The distance 862 may have a first range of about 0 inches (0 cm) to about 23 inches (58.42 cm), and a second range of about 0.25 inches (0.635 cm) to about 1 inch (2.54 cm). In one embodiment, the distance 862 may be about 0.25 inches (0.635 cm). In another embodiment, the width 860 may be about 7 inches (17.78 cm). The patterning may be offset a distance 862 from the side edges. The distance 862 may have a first range of about 0.125 inches (0.317 cm) to about 5 inches (12.7 cm), and a second range of about 0.25 inches (0.635 cm) to about 1 inch (2.54 cm). In one embodiment, the distance 862 may be about 0.5 inches (1.27 cm). The distance 862 from the edge 810 may be different than the distance 862 from the edge 812. By spacing the pattern away from the side edges, the seals at the side edges may be better than if the seals were made with the pattern at the side edges. This may occur because the material is more planar at the side edges to form the seal.

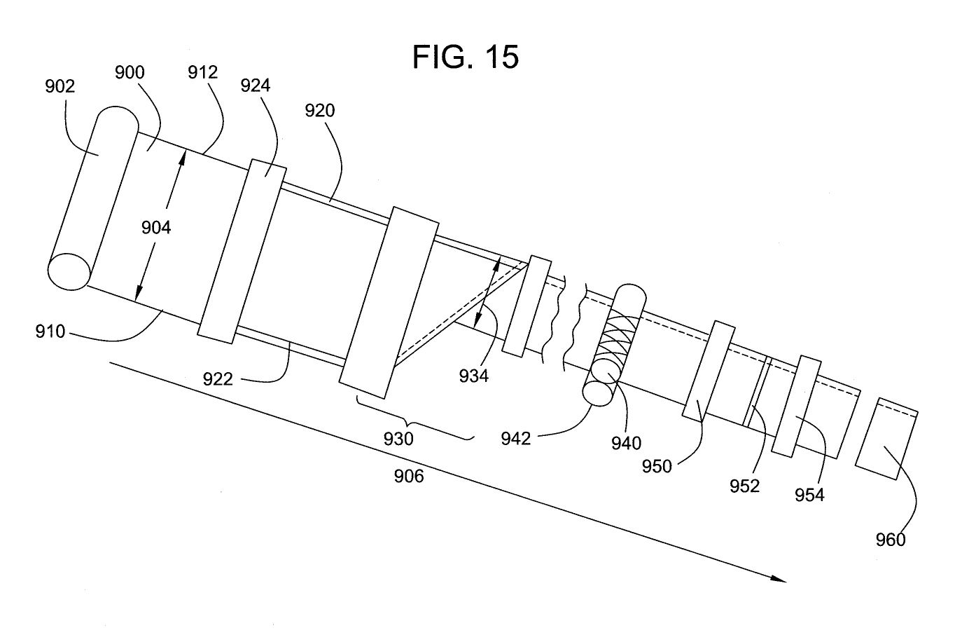

Manufacturing of a bag with a pattern may be accomplished in a number of different ways. To minimize the incremental costs of the bags, manufacturing may be accomplished in a high-speed automated process. For example, referring to FIG. 15, there is illustrated a schematic of an embodiment for high-speed automated manufacturing of bags. Production of the bags may start with providing a web 900 of pliable thermoplastic material wound into a roll 902. The web 900 may have a width 904 as measured between the first and second side edges 910, 912. The web 900 may be unwound from the roll and may be directed along a machine direction 906. In another embodiment, the web 900 may be extruded as part of the process. The web 900 may be directed through a machine 924 that may attach the first and second interlocking fastening strips 920, 922 near the first and second edges 910, 912. The web 900 may then be folded in half via a folding operation 930 so that the first edge 910 is moved adjacent the second edge 912. The web 900 may have a width 934 that may be half of the initial width 904. Also, the fastening strips 920, 922 may be adjacent and opposite each other. In another embodiment, the web 900 may be folded in half onto the roll 902. Thus, the folding operation 930 may not be needed.

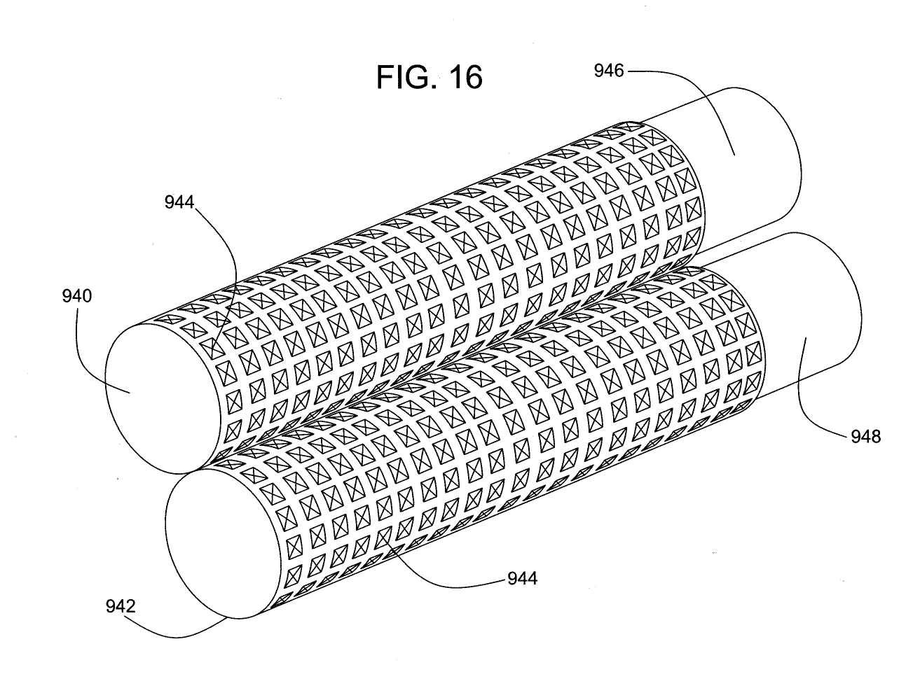

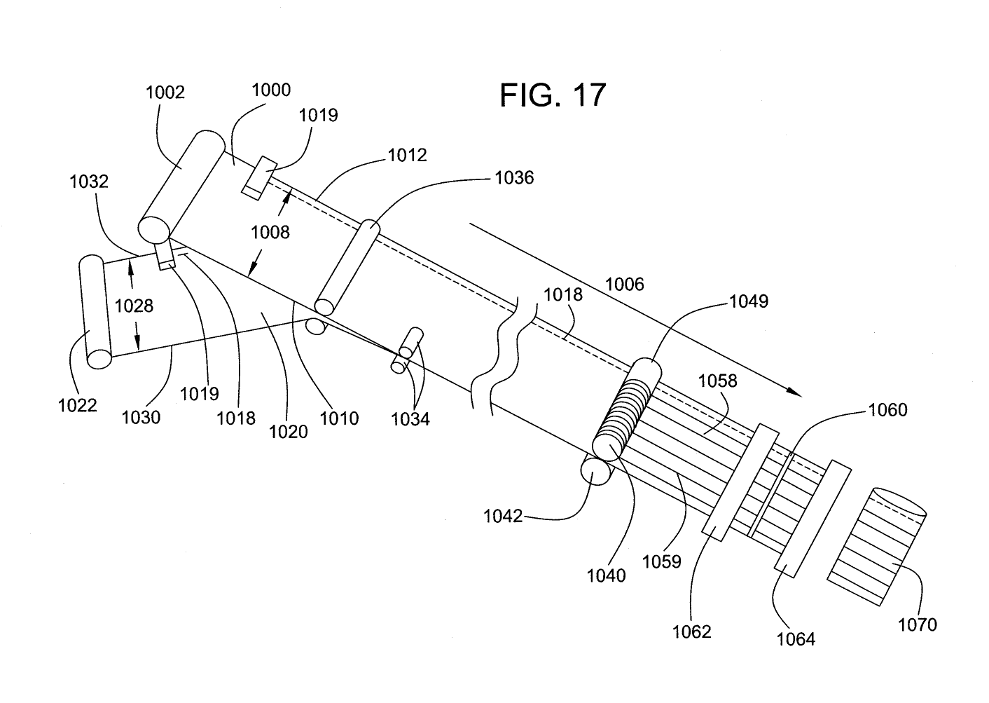

To apply the pattern to the web, two cylindrical rollers 940, 942 may be provided. The rollers 940, 942 may be arranged parallel and adjacent to each other and perpendicular to the machine direction 906. The web 900 may be directed between the rollers 940, 942 which may be made to rotate in opposite directions. The cylindrical surfaces of the rollers 940, 942 may have a pattern including a plurality of raised portions 944 as illustrated in FIG. 16. The raised portions 944 may extend both radially about the cylindrical rollers 940, 942 and axially along the cylindrical rollers. The raised portions 944 may correlate to the ribs that may be formed into the finished bag. Accordingly, as the web is directed between the rollers, the pattern may be formed into the thermoplastic material. Additionally, as illustrated, the cylindrical surface at an end 946, 948 of each roller may lack the raised portions 944 and may be smooth. Hence, when the web 900 is directed between the rollers 940, 942 as illustrated in FIG. 15 the fastening strips 920, 922 may pass between the smooth ends 946, 948 and may not formed with the pattern. In various embodiments, directing the web 900 between the opposing rollers 940, 942 may result in decreasing the thickness of the web. When the thickness of the web is reduced, the webs may take on different strength or tear characteristics. The rollers 940, 942 may be used in place of the rollers 1040, 1042 in the process shown in FIG. 17.

The web may be directed through other processing steps to further process the finished bag. For example, the web 900 may be directed through a side sealing operation 950 in which the folded web may be sealed together by side seals 952. As may be appreciated, the side seals 952 may correspond to the side edges of the finished bag. The web may be directed through a cutting operation 954 so that individual bags 960 may be separated from the web and placed in packaging. In another embodiment, the side seal and cutting operations may be performed at the same time.

Referring to FIG. 17, there is illustrated another embodiment of a manufacturing process for producing a thermoplastic bag for storing food items. The process may employ multiple thermoplastic webs including a first web 1000 wound into a first roll 1002 and a second web 1020 wound into a second roll 1022. The first web 1000 may be unwound and directed in a machine direction 1006 by the processing equipment. The first web 1000 may have a width 1008 as measured between first and second edges 1010, 1012. The second web 1020 may have width 1028 measured between the first and second edges 1030, 1032 of the second web. The first and second widths 1008, 1028 may be equal or different. In another embodiment, the webs 1000, 1020 may be extruded as part of the process. In addition, the processing equipment may include appropriately placed devices 1019 that may attach fastening strips 1018 to the surfaces of the webs 1000, 1020 proximate the respective second edges 1012, 1032 of the webs.

The second web 1020 may be directed by appropriately placed rollers 1036 or bars to be parallel and adjacent to the first web 1000 and directed along the machine direction 1006. Accordingly, the edges 1010, 1012 of the first web 1000 and the edges 1030, 1032 of the second web 1020 may be adjacent to and aligned with each other. The adjacent edges 1010, 1030 may be sealed together by heat or drag seals by passing the webs 1000, 1020 together between appropriately located rollers 1034.

To form the patterning onto the webs, the processing equipment may include a first cylindrical roller 1040 and an adjacently arranged second cylindrical roller 1042 that accomplish the forming process. The rollers 1040, 1042 may be arranged so that their longitudinal axes are perpendicular to the machine direction 1006 and may be adapted to rotate about their longitudinal axes in opposite rotational directions.

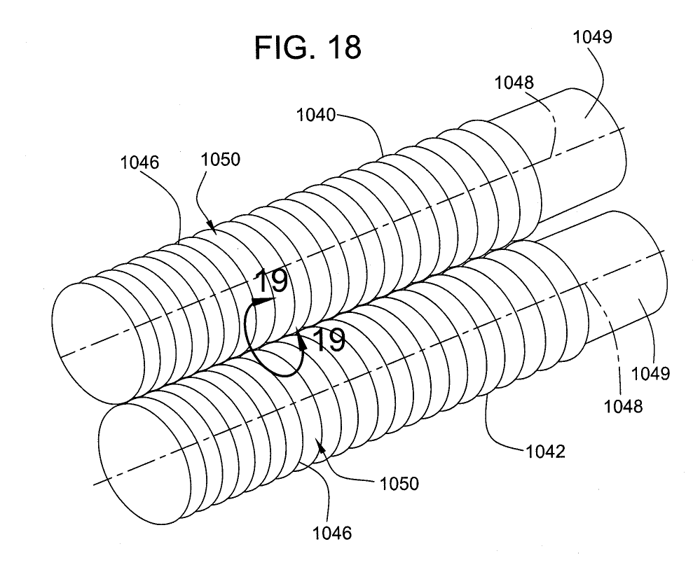

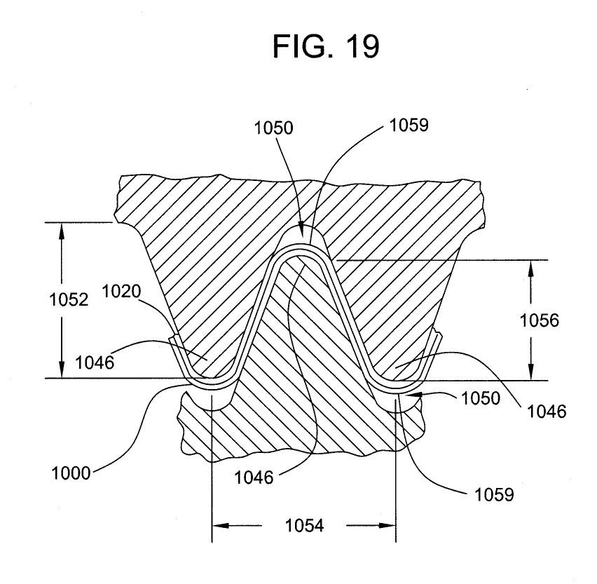

Referring to FIGS. 18 and 19, the cylindrical surface of both the first and second rollers 1040, 1042 may include a plurality of protruding ridges 1046 that may encircle the cylindrical axis 1048. The circular ridges 1046 may be arranged parallel to one another and extend along the axial length of the cylinder. Moreover, the circular ridges 1046 may be spaced apart from one another to provide corresponding grooves 1050 therebetween. The pattern of the circular ridges 1046 on the first roller 1040 may be axially offset or staggered with respect to the pattern of circular ridges on the second roller 1042 such that, when the rollers are aligned adjacently, the ridges of each roller may be received in and accommodated by the grooves 1050 of the other roller. In this manner, the alternating ridges 1046 and grooves 1050 of the two cylindrical rollers may mesh together.

The rollers and the ridge and groove features may have any suitable dimensions, taking into consideration the web material and web size to be processed. The ridges 1046 may have a peak height 1052 in a first range of about 0.01 inches (0.0254 cm) to about 0.5 inches (1.27 cm), and a second range of about 0.075 inches (0.1905 cm) to about 0.15 inches (0.381 cm). In one embodiment, the peak height 1052 may be about 0.1 inches (0.254 cm). The ridges 1046 may have a peak to peak spacing, or pitch 1054, in a first range of about 0.03 inches (0.0762 cm) to about 0.5 inches (1.27 cm), and a second range of about 0.04 inches (0.1016 cm) to about 0.06 inches (0.1524 cm). In one embodiment, the pitch 1054 may be about 0.06 inches (0.1524 cm). The ridges may have a height 1052 to pitch 1054 ratio in a first range of about 0.1:1 to about 5:1, and a second range of about 1:1 to about 3:1. In one embodiment, the height to pitch ratio may be about 1.7:1. The longitudinal axes 1048 of the rollers 1040, 1042 may be spaced apart such that only a portion of the circular ridge 1046 is received in the corresponding groove 1050. The height of the ridge 1046 that is received within the groove 1050 may be termed the depth of engagement 1056. The depth of engagement 1056 may be in a first range of about 0.005 inches (0.0127 cm) to about 0.5 inches (1.27 cm), and a second range of about 0.04 inches (0.1016 cm) to about 0.2 inches (0.508 cm). In one embodiment, the depth of engagement 1056 may be about 0.03 inches (0.076 cm).

Referring to FIG. 17, the joined webs 1000, 1020 may be advanced along the machine direction 1006 between the first and second rollers 1040, 1042 which may be set into rotation in opposite rotational directions to form the resulting web pattern 1058. As illustrated in FIG. 19, the ridges 1046 may displace the webs 1000, 1020 into the corresponding grooves 1050. The meshing action of the ridges 1046 and grooves 1050 may form onto the web 1000, 1020, a pattern or shape. The arrangement of alternating circular ridges 1046 and corresponding grooves 1050 may produce a series of linear ribs 1059 onto the webs 1000, 1020, which the web may at least partially maintain after passing between the rollers. Because the circular ridges 1046 may be aligned in parallel and spaced apart, the resulting ribs 1059 may be parallel to one another and may have the same spacing or pitch. To facilitate patterning of the webs 1000, 1020, the first roller 1040 and second roller 1042 may be forced or directed against each other by, for example, hydraulic or pneumatic actuators. The pressure at which the rollers are pressed together may be in a first range from about 30 PSI (2.04 atm) to about 100 PSI (6.80 atm), and a second range from about 60 PSI (4.08 atm) to about 90 PSI (6.12 atm). In one embodiment, the pressure may be about 80 PSI (5.44 atm). The pressure ranges noted above may be for cylinders with a diameter from about 1 inch (2.54 cm) to about 12 inches (30.48 cm) and a pattern width in a range from about 2 inches (5.08 cm) to about 60 inches (152.4 cm).

In the illustrated embodiment, the first and second rollers may be arranged so that they are co-extensive with or wider than the widths 1008, 1028 of the joined webs. In one embodiment, the rollers 1040, 1042 may extend from proximate the outer edges 1010, 1030 to the adjacent edges 1012, 1032. To avert imparting the pattern onto the portion of the web that includes the fastening strips 1018, the corresponding ends 1049 of the rollers 1040, 1042 may be smooth and without the ridges and grooves. Hence, the adjacent edges 1012, 1032 and the corresponding portion of the webs proximate those edges that pass between the smooth ends 1049 of the rollers 1040, 1042 may not have the pattern.

The joined webs may be directed through additional processing equipment to produce the finished bag 1070. For example, the processing environment may include a sealer 1062 that forms the intermittent side seals 1060 joining the webs together. Additionally, the webs 1000, 1020 may be directed through a cutting operation 1064 in which the side seals 1060 may be cut into individual bags 1070. In another embodiment, the side seal and cutting operation may be performed at the same time.

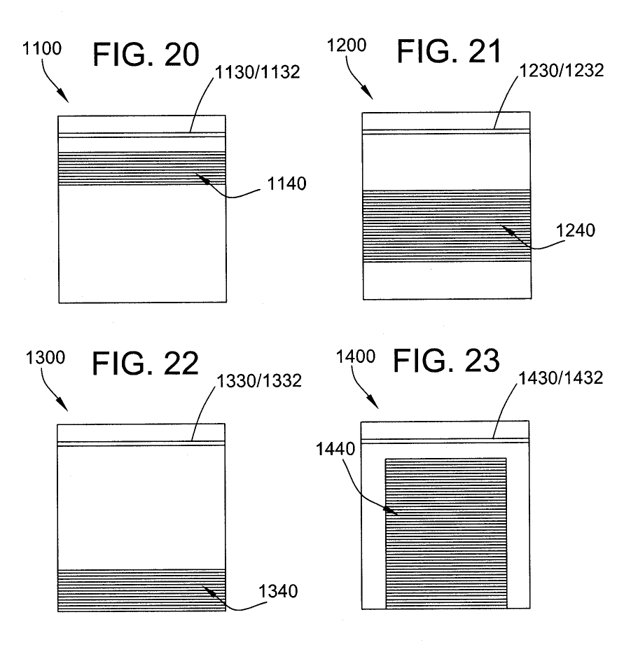

Referring to FIG. 20, the bag 1100 is similar to the bag 500 in FIG. 11 except the pattern 1140 is similar to the pattern 240 in FIG. 4. The pattern 1140 may have the same dimensional information as the bag 500 in FIG. 11. The bag 1100 may include fastening strips 1130, 1132. In other embodiments, the bag may have any of the closures disclosed herein, as appropriate.

Referring to FIG. 21, the bag 1200 is similar to the bag 600 in FIG. 12 except the pattern 1240 is similar to the pattern 240 in FIG. 4. The pattern 1240 may have the same dimensional information as the bag 600 in FIG. 12. The bag 1200 may include fastening strips 1230, 1232. In other embodiments, the bag may have any of the closures disclosed herein, as appropriate.

Referring to FIG. 22, the bag 1300 is similar to the bag 700 in FIG. 13 except the pattern 1340 is similar to the pattern 240 in FIG. 4. The pattern 1340 may have the same dimensional information as the bag 700 in FIG. 13. The bag 1300 may include fastening strips 1330, 1332. In other embodiments, the bag may have any of the closures disclosed herein, as appropriate.

Referring to FIG. 23, the bag 1400 is similar to the bag 800 in FIG. 14 except the pattern 1440 is similar to the pattern 240 in FIG. 4. The pattern 1440 may have the same dimensional information as the bag 800 in FIG. 14. The bag 1400 may include fastening strips 1430, 1432. In other embodiments, the bag may have any of the closures disclosed herein, as appropriate.

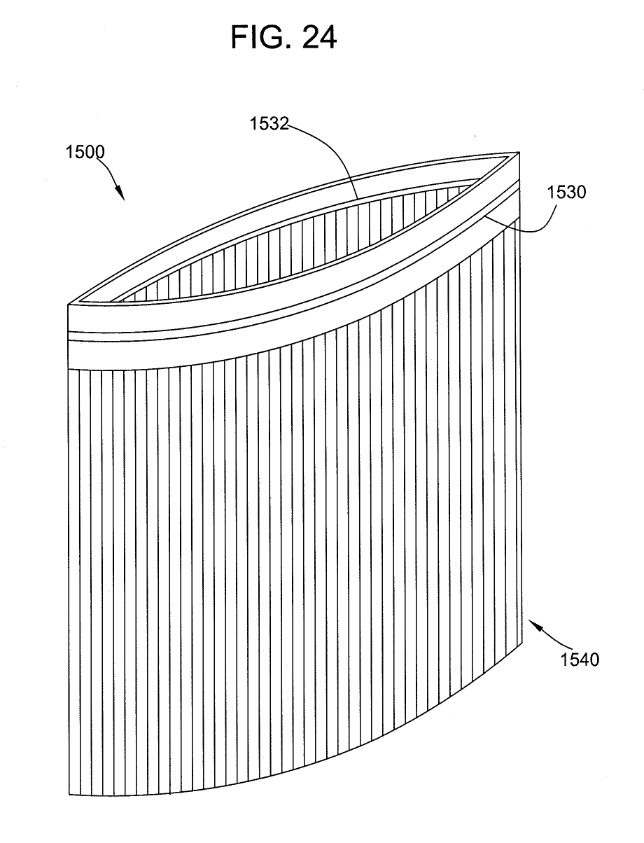

Referring to FIG. 24, the bag 1500 may be similar to bag 200 in FIG. 4 except that the pattern 1540 may be in the vertical direction. The pattern 1540 may have the same dimensional information as the bag 200 in FIG. 4. The bag 1500 may include fastening strips 1530, 1532. In other embodiments, the bag may have any of the closures disclosed herein, as appropriate.

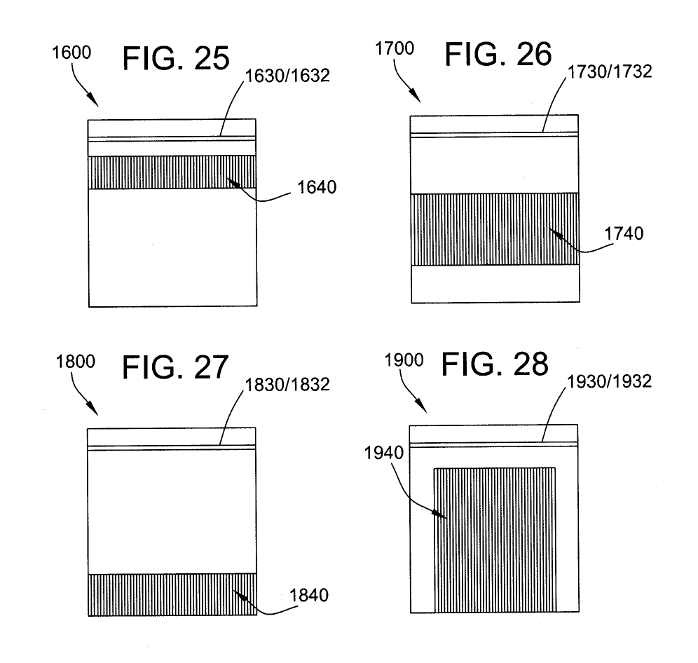

Referring to FIG. 25, the bag 1600 may be similar to the bag 1100 in FIG. 20 except the pattern 1640 may be similar to the pattern 1540 in FIG. 24. The pattern 1640 may have the same dimensional information as the bag 1100 in FIG. 20. The bag 1600 may include fastening strips 1630, 1632. In other embodiments, the bag may have any of the closures disclosed herein, as appropriate.

Referring to FIG. 26, the bag 1700 may be similar to the bag 1200 in FIG. 21 except the pattern 1740 may be similar to the pattern 1540 in FIG. 24. The pattern 1740 may have the same dimensional information as the bag 1200 in FIG. 21. The bag 1700 may include fastening strips 1730, 1732. In other embodiments, the bag may have any of the closures disclosed herein, as appropriate.

Referring to FIG. 27, the bag 1800 may be similar to the bag 1300 in FIG. 22 except the pattern 1840 may be similar to the pattern 1540 in FIG. 24. The pattern 1840 may have the same dimensional information as the bag 1300 in FIG. 22. The bag 1800 may include fastening strips 1830, 1832. In other embodiments, the bag may have any of the closures disclosed herein, as appropriate.

Referring to FIG. 28, the bag 1900 may be similar to the bag 1400 in FIG. 23 except the pattern 1940 may be similar to the pattern 1540 in FIG. 24. The pattern 1940 may have the same dimensional information as the bag 1400 in FIG. 23. The bag 1900 may include fastening strips 1930, 1932. In other embodiments, the bag may have any of the closures disclosed herein, as appropriate.

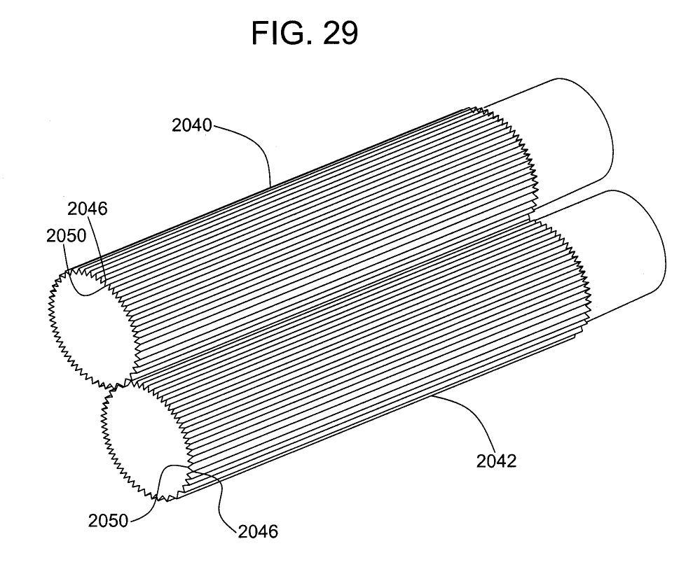

Referring to FIG. 29, another embodiment of a pair of rollers 2040, 2042 is shown. The rollers 2040, 2042 may include a plurality of protruding ridges 2046 that may extend along the length of the rollers. The ridges 2046 may be arranged parallel to one another. The ridges 2046 may be spaced apart from one another to provide corresponding grooves 2050 therebetween. The pattern of the ridges 2046 on the first roller 2040 may be axially offset or staggered with respect to the pattern of ridges on the second roller 2042 such that, when the rollers are aligned adjacently, the ridges 2046 of each roller may be received in and accommodated by the grooves 2050 of the other roller. In this manner, the alternating ridges 2046 and grooves 2050 of the two rollers may mesh together. The rollers 2040, 2042 may have the same dimensional information as the rollers 1040, 1042 in FIGS. 18 and 19. The rollers 2040, 2042 may be used to form the pattern 1540 for the bag in FIG. 24.

The flexible bag may be provided with different embodiments of fastening strips and the fastening strips may be activated by a user's fingers or by a slider. For example, referring to FIG. 30, there is illustrated a flexible bag 2100 having overlapping first and second sidewalls that are joined along parallel first and second side edges 2110, 2112, and a perpendicular closed bottom edge 2114 to define an internal volume 2106. To access the internal volume 2106, the portions of the first and second sidewalls 2102, 2104 that are opposite the closed bottom edge 2114 remain unjoined to form an open top edge 2116. To releasably close the open top edge 2116, the flexible bag 2100 includes a first fastening strip 2130 and a second fastening strip 2131 that engage a movable slider 2132.

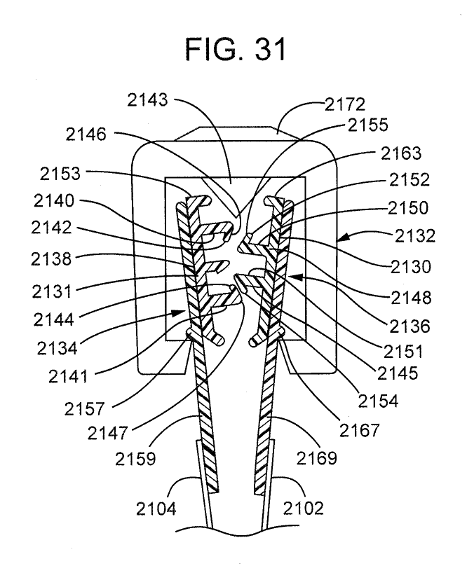

As shown in FIG. 31, the fastening strips may be U-channel fastening strips as described in U.S. Pat. No. 4,829,641, herein incorporated by reference in its entirety. U-channel fastening strips include a first fastening strip 2130 with a first closure element 2136 and a second fastening strip 2131 with a second closure element 2134. The first closure element 2136 engages the second closure element 2134. The first fastening strip 2130 may include a flange 2163 disposed at the upper end of the first fastening strip 2130 and a rib 2167 disposed at the lower end of the first fastening strip 2130. The first fastening strip 2130 may include a flange portion 2169. Likewise, the second fastening strip 2131 may include a flange 2153 disposed at the upper end of the second fastening strip 2131 and a rib 2157 disposed at the lower end of the second fastening strip 2131. The second fastening strip 2131 may include a flange portion 2159. The sidewalls 2102, 2104 of the plastic bag 2100 may be attached to the fastening strips 2130, 2131 by conventional manufacturing techniques.

The second closure element 2134 includes a base portion 2138 having a pair of spaced-apart parallelly disposed webs 2140, 2141, extending from the base portion 2138. The base and the webs form a U-channel closure element. The webs 2140, include hook closure portions 2142, 2144 extending from the webs 2140, 2141 respectively, and facing towards each other. The hook closure portions 2142, 2144 include guide surfaces 2146, 2147 which serve to guide the hook closure portions 2142, 2144 for occluding with the hook closure portions 2152, 2154 of the first closure element 2136.

The first closure element 2136 includes a base portion 2148 including a pair of spaced-apart, parallelly disposed webs 2150, 2151 extending from the base portion 2148. The base and the webs form a U-channel closure element. The webs 2150, 2151 include hook closure portions 2152, 2154 extending from the webs 2150, 2151 respectively and facing away from each other. The hook closure portions 2152, 2154 include guide surfaces 2145, 2155, which generally serve to guide the hook closure portions 2152, 2154 for occlusion with the hook closure portions 2142, 2144 of the second closure element 2134. The guide surfaces 2145, 2155 may also have a rounded crown surface.

The fastening strips 2130, 2131 may be opened and closed by using the slider 2132. The slider 2132 includes a top portion 2172. The top portion provides a separator 2143 having a first end and a second end wherein the first end may be wider than the second end. In addition, the separator 2143 may be triangular in shape. When the slider is moved in the occlusion direction, the separator 2143 deoccludes the fastening strips 2130, 2131 as shown in FIG. 31. Referring to FIG. 31, the closure elements 2134, 2136 are deoccluded and specifically, the upper hook portions 2142, 2152 and the lower hook portions 2144, 2154 are deoccluded. In another embodiment, the bag 2100 may not include the slider 2132 and the user may open and close the fastening strips 2130, 2131 by using his or her fingers. These embodiments of the fastening strips with or without the slider may be used with any of the embodiments described herein, as appropriate.

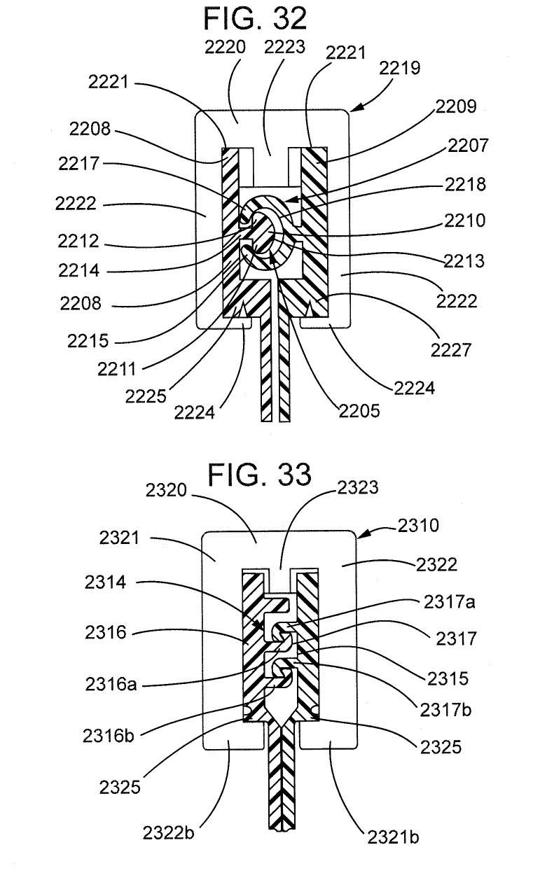

The interlocking fastening strips may comprise “arrowhead-type” or “rib and groove” fastening strips as shown in FIG. 32 and as described in U.S. Pat. No. 3,806,998 herein incorporated by reference in its entirety. The rib element 2205 interlocks with the groove element 2207. The rib element 2205 is of generally arrow-shape in transverse cross section including a head 2210 comprising interlock shoulder hook portions 2211 and 2212 generally convergently related to provide a cam ridge 2213 generally aligned with a stem flange 2214 by which the head is connected in spaced relation with respect to the supporting flange portion 2208. (U.S. Pat. No. 3,806,998, Col. 2, lines 16-23). At their surfaces nearest the connecting stem flange 2214, the shoulder portions 2211 and 2212 define reentrant angles therewith providing interlock hooks engageable with interlock hook flanges 2215 and 2217 respectively of the groove element 2207. (U.S. Pat. No. 3,806,998, Col. 2, lines 23-28). Said hook flanges generally converge toward one another and are spread open to receive the head 2210 therebetween when said head is pressed into said groove element 2207 until the head is fully received in a groove 2218 of said groove element 2207 generally complementary to the head and within which the head is interlocked by interengagement of the head shoulder hook portions 2211 and 2212 and the groove hook flanges 2215 and 2217. (U.S. Pat. No. 3,806,998, Col. 2, lines 28-36). Through this arrangement, as indicated, the head and groove elements 2205 and 2207 are adapted to be interlockingly engaged by being pressed together and to be separated when forcibly pulled apart, as by means of a generally U-shaped slider 2219. (U.S. Pat. No. 3,806,998, Col. 2, lines 36-41).

The slider 2219 includes a flat back plate 2220 adapted to run along free edges 2221 on the upper ends of the sections of the flange portions 2208 and 2209 as shown in the drawing. (U.S. Pat. No. 3,806,998, Col. 2, lines 41-46). Integrally formed with the back plate 2220 and extending in the same direction (downwardly as shown) therefrom are respective coextensive sidewalls 2222 with an intermediate spreader finger 2223 extending in the same direction as the sidewalls at one end of the slider. (U.S. Pat. No. 3,806,998, Col. 2, lines 46-51). The sidewalls 2222 are in the form of panels which are laterally divergent from a narrower end of the slider. (U.S. Pat. No. 3,806,998, Col. 2, lines 51-55). The slider walls 2222 are each provided with an inwardly projecting shoulder structure 2224 flange adapted to engage respective shoulder ribs 2225 and 2227 on respectively outer sides of the lower section of the flange portions 2208 and 2209. (U.S. Pat. No. 3,806,998, Col. 2, line 66 to Col. 3, line 3). In another embodiment, the bag may not include the slider 2219 and the user may open and close the fastening strips by using his or her fingers. These embodiments of the fastening strips with or without may be used with any of the embodiments described herein, as appropriate.

Additionally, the interlocking fastening strips may comprise “profile” fastening strips, as shown in FIG. 33 and described in U.S. Pat. No. 5,664,299 herein incorporated by reference in its entirety. As shown in FIG. 33, the first profile 2316 has at least an uppermost closure element 2316a and a bottommost closure element 2316b. (U.S. Pat. No. 5,664,299, Col. 3, lines 25-27). The closure elements 2316a and 2316b project laterally from the inner surface of strip 2314. (U.S. Pat. No. 5,664,299, Col. 3, lines 27-28). Likewise, the second profile 2317 has at least an uppermost closure element 2317a and a bottommost closure element 2317b. (U.S. Pat. No. 5,664,299, Col. 3, lines 28-30). The closure elements 2317a and 2317b project laterally from the inner surface of strip 2315. (U.S. Pat. No. 5,664,299, Col. 3, lines 30-32). When the bag is closed, the closure elements of profile 2316 interlock with the corresponding closure elements of profile 2317. (U.S. Pat. No. 5,664,299, Col. 3, lines 32-34). As shown in FIG. 26, closure elements 2316a, 2316b, 2317a and 2317b have hooks on the ends of the closure elements, so that the profiles remain interlocked when the bag is closed, thereby forming a seal. (U.S. Pat. No. 5,664,299, Col. 3, lines 34-37).

The fastening strips may be opened and closed by using the slider 2310. The straddling slider 2310 comprises an inverted U-shaped member having a top 2320 for moving along the top edges of the strips 2314 and 2315. (U.S. Pat. No. 5,664,299, Col. 4, lines 1-3). The slider 2310 has sidewalls 2321 and 2322 depending from the top 2320. (U.S. Pat. No. 5,664,299, Col. 4, lines 3-4). A separating leg 2323 depends from the top 2320 between the sidewalls 2321 and 2322 and is located between the uppermost closure elements 2316a and 2317a of profiles 2316 and 2317. (U.S. Pat. No. 5,664,299, Col. 4, lines 26-30). The fastening assembly includes ridges 2325 on the outer surfaces of the fastening strips 2314 and 2315, and shoulders 2321b and 2322b on the sidewalls of the slider. (U.S. Pat. No. 5,664,299, Col. 4, lines 62-65). The shoulders act as means for maintaining the slider in straddling relation with the fastening strips by grasping the lower surfaces of the ridges 2325. (U.S. Pat. No. 5,664,299, Col. 5, lines 4-7). In another embodiment, the bag may not include the slider 2310 and the user may open and close the fastening strips by using his or her fingers. These embodiments of the fastening strips with or without the slider may be used with any of the embodiments described herein, as appropriate.

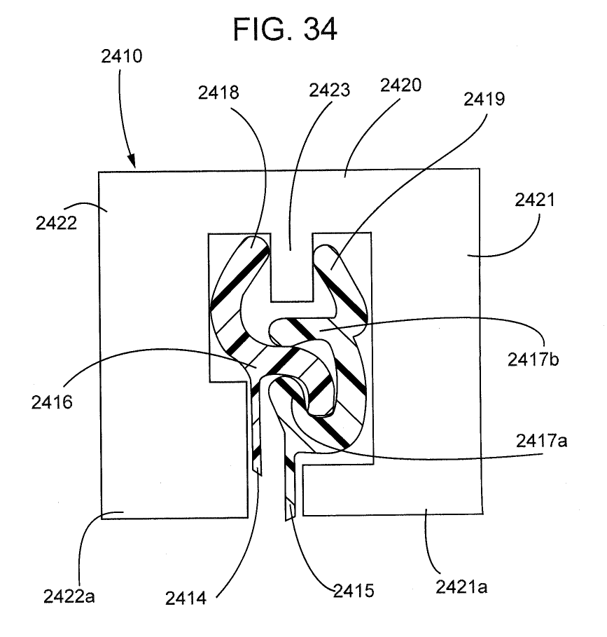

Also, the interlocking fastening strips may be “rolling action” fastening strips as shown in FIG. 34 and described in U.S. Pat. No. 5,007,143 herein incorporated by reference in its entirety. The strips 2414 and 2415 include profiled tracks 2418 and 2419 extending along the length thereof parallel to the rib and groove elements 2416 and 2417 and the rib and groove elements 2416, 2417 have complimentary cross-sectional shapes such that they are closed by pressing the bottom of the elements together first and then rolling the elements to a closed position toward the top thereof. (U.S. Pat. No. 5,007,143, Col. 4, line 62 to Col. 5, line 1). The rib element 2416 is hook shaped and projects from the inner face of strip 2414. (U.S. Pat. No. 5,007,143, Col. 5, lines 1-3). The groove element 2417 includes a lower hook-shaped projection 2417a and a relatively straight projection 2417b which extend from the inner face of strip 2415. (U.S. Pat. No. 5,007,143, Col. 5, lines 3-6). The profiled tracks 2418 and 2419 are inclined inwardly toward each other from their respective strips 2414 and 2415. (U.S. Pat. No. 5,007,143, Col. 5, lines 6-8). This embodiment of the fastening strips and slider may be used with any of the embodiments described herein, as appropriate.

The straddling slider 2410 may comprise an inverted U-shaped plastic member having a back 2420 for moving along the top edges of the tracks 2418 and 2419 with sidewalls 2421 and 2422 depending therefrom for cooperating with the tracks and extending from an opening end of the slider to a closing end. (U.S. Pat. No. 5,007,143, Col. 5, lines 26-31). A separator finger 2423 depends from the back 2420 between the sidewalls 2421 and 2422 and is inserted between the inclined tracks 2418 and 2419. (U.S. Pat. No. 5,007,143, Col. 5, lines 34-36). The slider 2410 has shoulders 2421a and 2422a projecting inwardly from the depending sidewalls 2421 and 2422 which are shaped throughout the length thereof for cooperation with the depending separator finger 2423 in creating the rolling action in opening and closing the reclosable interlocking rib and groove profile elements 2416 and 2417. (U.S. Pat. No. 5,007,143, Col. 5, lines 43-49).

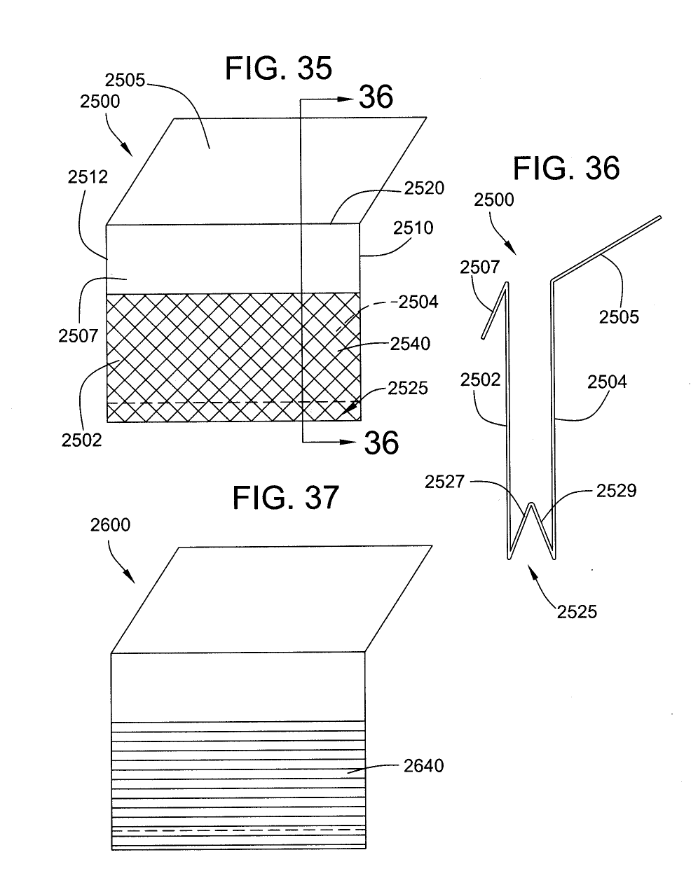

Referring to FIGS. 35 and 36, another embodiment of a bag 2500 is shown. The bag 2500 may be a fold top bag. The bag 2500 may include a first sidewall 2502 and a second sidewall 2504. The bag 2500 may include an upper flap 2505 and a lower flap 2507. The lower flap 2507 may be connected to the first sidewall 2502 along three edges 2510, 2512, 2520. A user may tuck the upper flap 2505 into the interior of the bag 2500 and then roll the lower flap 2507 over the upper flap 2505 until the lower flap 2507 contacts the second sidewall 2504. The bag 2500 may include a gusset 2525. The gusset 2525 may include two portions 2527, 2529 of the sidewalls which extend upward and may be sealed at the side edges 2510, 2512. The gusset 2525 may allow the bag to expand to accommodate items inserted into the bag. In other embodiments, the bag may not have a gusset. The bag 2500 may have a pattern 2540. The pattern 2540 may be similar to the pattern 140 in FIG. 1. In other embodiments, the bag may have any of the patterns disclosed herein, as appropriate.

Referring to FIG. 37, another embodiment of a bag 2600 is shown. The bag 2600 may be similar to the bag 2500 in FIG. 35 except that the pattern 2640 may be similar to the pattern 240 in FIG. 4. In other embodiments, the bag may have any of the patterns disclosed herein, as appropriate.

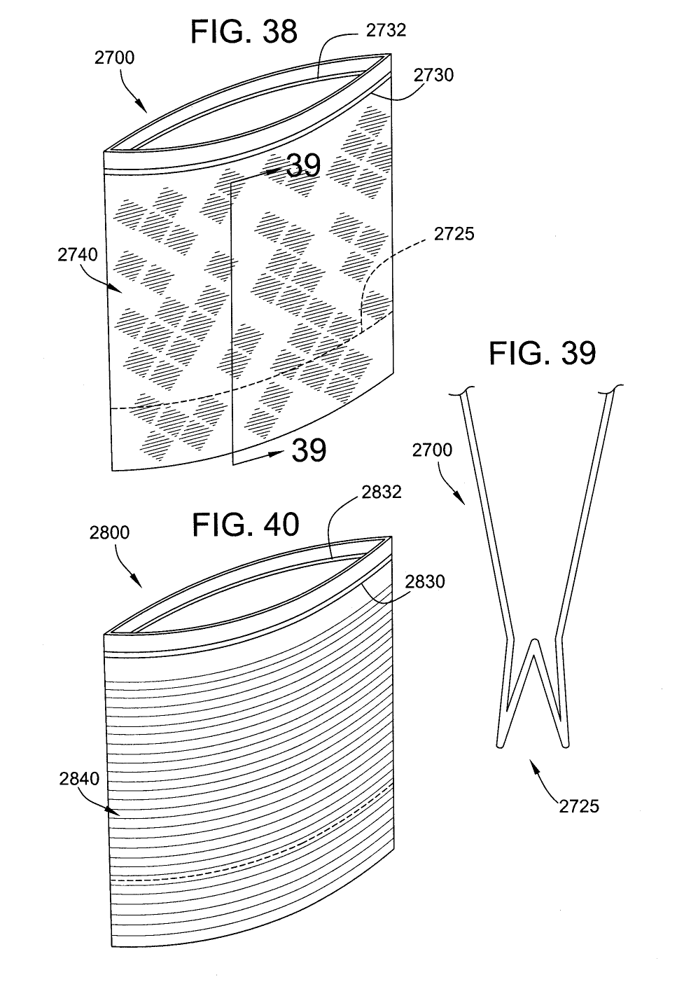

Referring to FIGS. 38 and 39, another embodiment of a bag 2700 is shown. The bag 2700 may be similar to bag 100 in FIG. 1 except that the bag 2700 may have a gusset 2725. The gusset 2725 may be similar to the gusset 2525 in FIGS. 35 and 36. The bag 2700 may have a pattern 2740 similar to pattern 140 in FIG. 1. In other embodiments, the bag may have any of the patterns disclosed herein, as appropriate. The bag 2700 may include fastening strips 2730, 2732. In other embodiments, the bag may have any of the closures disclosed herein, as appropriate.

Referring to FIG. 40, another embodiment of a bag 2800 is shown. The bag 2800 may be similar to bag 2700 except that the bag 2800 may have a pattern 2840 similar to the pattern 240 in FIG. 4. In other embodiments, the bag may have any of the patterns disclosed herein, as appropriate. The bag 2800 may include fastening strips 2830, 2832. In other embodiments, the bag may have any of the closures disclosed herein, as appropriate.

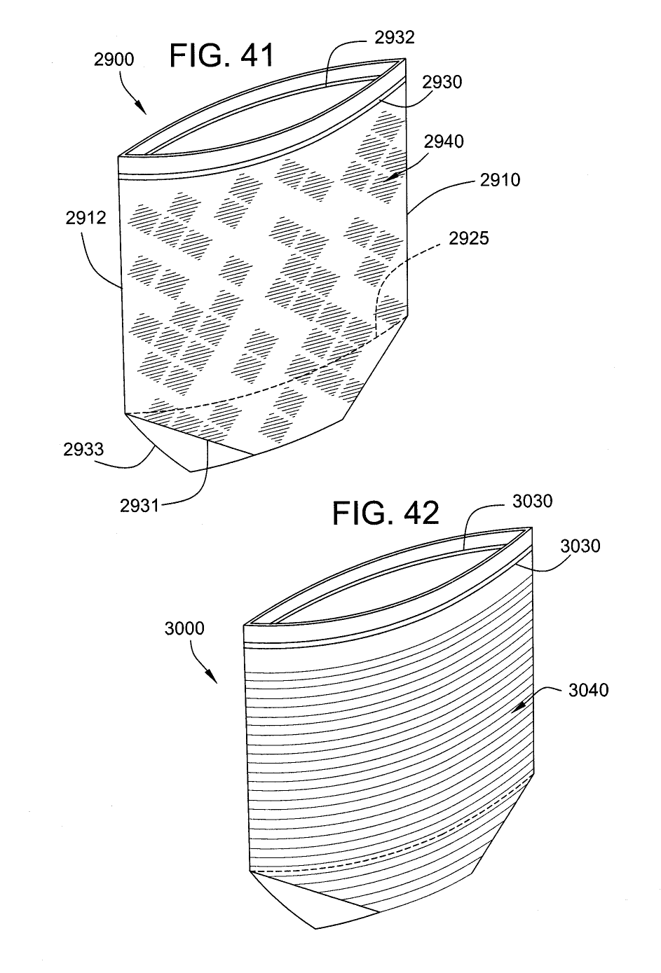

Referring to FIG. 41, another embodiment of a bag 2900 is shown. The bag 2900 may be similar to bag 2700 except that the gusset may have side seals 2931, 2933 which may allow the bag 2900 to stand up on the gusset 2925. The side seals 2931, 2933 for the gusset may be at an angle with respect to side seals 2910, 2912. The bag 2900 may have pattern 2940 similar to pattern 140 in FIG. 1. In other embodiments, the bag may have any of the patterns disclosed herein, as appropriate. The bag 2900 may include fastening strips 2930, 2932. In other embodiments, the bag may have any of the closures disclosed herein, as appropriate.

Referring to FIG. 42, another embodiment of a bag 3000 is shown. The bag 3000 may be similar to bag 2900 except that the bag 3000 may have a pattern 3040 similar to the pattern 240 in FIG. 4. In other embodiments, the bag may have any of the patterns disclosed herein, as appropriate. The bag 3000 may include fastening strips 3030, 3032. In other embodiments, the bag may have any of the closures disclosed herein, as appropriate.

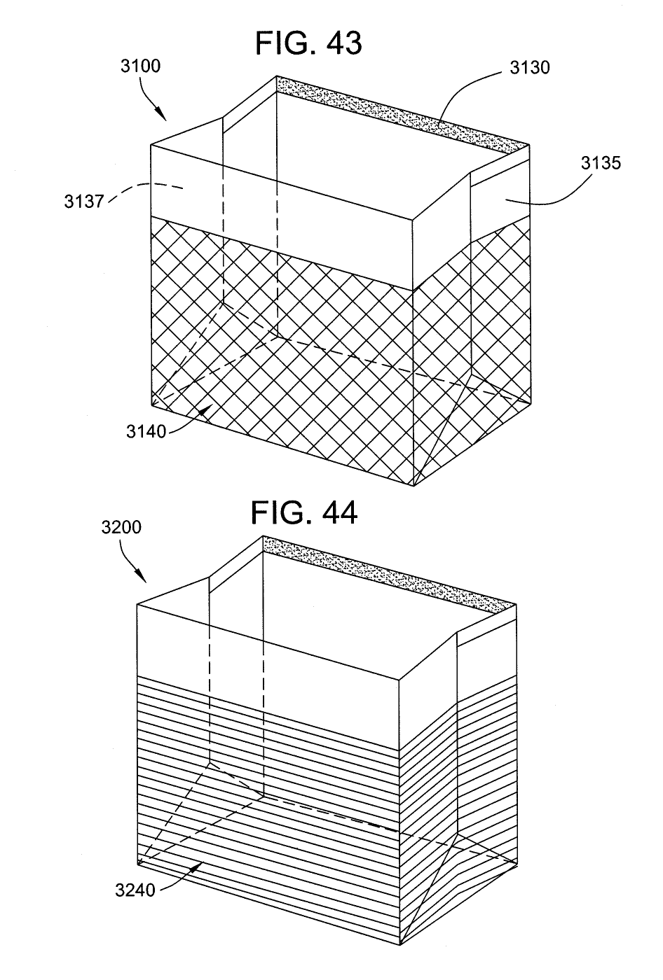

Referring to FIG. 43, another embodiment of a bag 3100 is shown. The bag 3100 may be similar to bag 100 in FIG. 1 except that the bag 3100 may have side gussets 3135, 3137. The bag 3100 may have an adhesive closure 3130. In other embodiments, the bag may have any of the closures disclosed herein, as appropriate. The bag 3100 may have a pattern 3140 similar to the pattern 140 in FIG. 1. In other embodiments, the bag may have any of the patterns disclosed herein, as appropriate.

Referring to FIG. 44, another embodiment of a bag 3200 is shown. The bag 3200 may be similar to bag 3100 except that the bag 3200 may have a pattern 3240 similar to the pattern 240 in FIG. 4. In other embodiments, the bag may have any of the patterns disclosed herein, as appropriate. In other embodiments, the bag may have any of the closures disclosed herein, as appropriate.

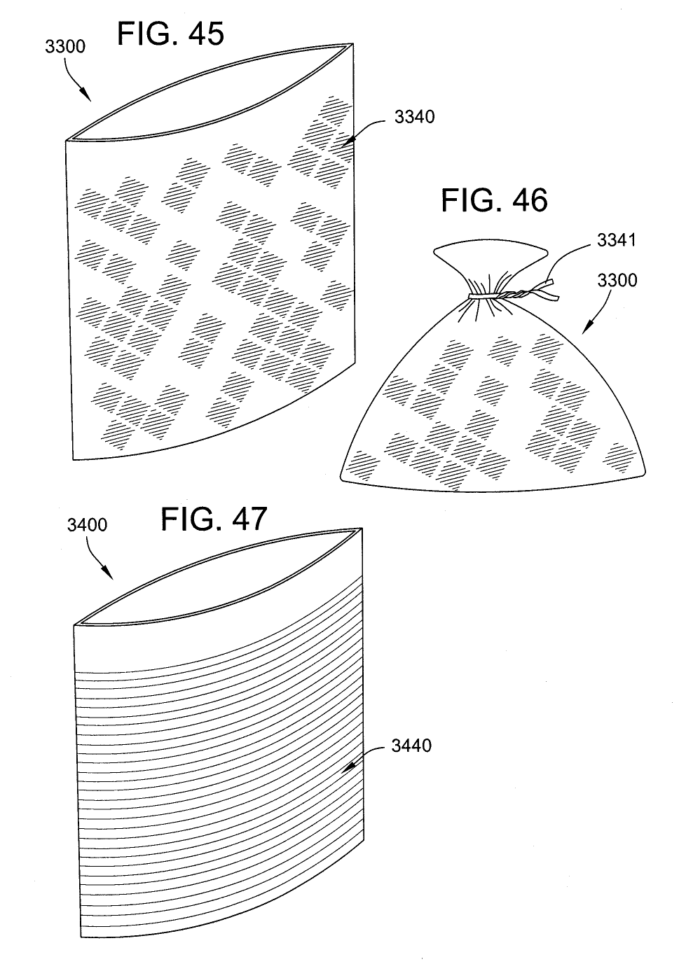

Referring to FIG. 45, another embodiment of a bag 3300 is shown. The bag 3300 may be similar to bag 100 in FIG. 1 except that the bag may not include fastening strips. The bag 3300 may use a twist tie 3341 as shown in FIG. 46. In other embodiments, the bag may have any of the closures disclosed herein, as appropriate. The bag 3300 may have a pattern 3340 similar to the pattern 140 in FIG. 1. In other embodiments, the bag may have any of the patterns disclosed herein, as appropriate.

Referring to FIG. 47, another embodiment of a bag 3400 is shown. The bag 3400 may be similar to bag 100 in FIG. 1 except that the bag may not include fastening strips. The bag 3400 may use a twist tie as shown in FIG. 46. In other embodiments, the bag may have any of the closures disclosed herein, as appropriate. The bag 3400 may have a pattern 3440 similar to the pattern 240 in FIG. 4. In other embodiments, the bag may have any of the patterns disclosed herein, as appropriate.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Exemplary embodiments are described herein. Variations of those embodiments may become apparent to those of ordinary skill in the art upon reading the foregoing description. The inventor(s) expect skilled artisans to employ such variations as appropriate, and the inventor(s) intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A bag for storing food comprising:
a first sidewall of pliable thermoplastic material;
a second sidewall of pliable thermoplastic material overlaid and joined to the first sidewall along a first edge, a second edge, and a bottom edge, the first and second sidewalls un-joined along respective top edges to provide an opening opposite the bottom edge for accessing the interior volume;
wherein at least a portion of one of the first or second sidewalls are formed with a plurality of ribs.

2. The bag of claim 1, wherein first and second interlocking closure strips are attached to the respective first and second sidewall proximate the opening.

3. The bag of claim 1, wherein the plurality of ribs are generally parallel with one another and with respect to the bottom edge

4. The bag of claim 1, wherein the plurality of ribs extend from the first side edge to the second side edge.

5. The bag of claim 1, wherein the plurality of ribs are spaced apart from the first and second side edges.

6. The bag of claim 1, wherein the plurality of ribs extend from the bottom edge toward the opening.

7. The bag of claim 1, wherein the plurality of ribs are spaced apart from the bottom edge.

8. The bag of claim 1, wherein the first and second sidewalls adhere to each other by at least some of the plurality of ribs pinching the opposite sidewall.

9. The bag of claim 2, wherein the ribs flatten out to facilitate the engagement of the first and second interlocking closure strips.

10. The bag of claim 1, wherein the ribs are generally parallel to the first edge.

11. The bag of claim 1, wherein the ribs are formed in a plurality of regions.

12. The bag of claim 1, wherein the bag includes a gusset.

13. A method of producing a bag for storing food items comprising:
directing a first web of flexible thermoplastic material along a machine direction, the first web having a first edge and a parallel, opposing second edge;
attaching interlocking fastening strips to the web proximate the first edge and the second edge;
folding the web so that the first edge and second edge are adjacent;
directing the web between opposing, parallel first and second rollers, at least one of the first and second rollers including a pattern, the pattern produces a series of parallel linear ribs; and
forming the web with the pattern.

14. The method of claim 13, wherein the ribs are formed parallel to the machine direction.

15. The method of claim 13, wherein the ribs are formed perpendicular to the machine direction.

16. The method of claim 13, wherein the cylindrical surface of each roller includes radial ridges protruding radially outward, the plurality of radial ridges arranged parallel to and axially spaced apart from each other, the radial ridges of the first cylindrical roller being received between the spaced-apart radial ridges of the second cylindrical roller.

17. The method of claim 13, further comprising:
forming first sealed side edge between the first and second sidewalls perpendicular to the machine direction; and forming a second sealed side edge between the first and second sidewalls perpendicular to the machine direction, the second sealed side edge spaced apart from the first sealed side edge.
